(19) United States
(12) Patent Application Publication
(10) Pub. No.: US 2026/0303250 A1
(43) Pub. Date: Oct. 1, 2026

(54) PROBABILISTIC AMPLITUDE SHAPING WITH FORWARD ERROR CORRECTION CODE RATE BASED ON MODULATION ORDER

(71) Applicant: QUALCOMM Incorporated, San Diego, CA (US)

(72) Inventors: Ronen SHAKED, Kfar Saba (IL); Gideon Shlomo KUTZ, Ramat Hasharon (IL)

(21) Appl. No.: 19/090,236

(22) Filed: Mar. 25, 2025

(51) Int. Cl. H04L 1/00

(52) U.S. Cl. CPC H04L 1/0003; H04L 1/0055; H04L 1/0063

(57) ABSTRACT

Systems and techniques are provided for wireless communication. For example, a network entity can obtain a set of shaped bits encoded according to a probabilistic amplitude shaping (PAS) configuration for a modulation scheme. A threshold native code rate for a forward error correction (FEC) encoder can be determined based on a modulation order of the modulation scheme. An encoding configuration for the FEC encoder corresponds to the threshold native code rate and is obtained from among a plurality of candidate encoding configurations each corresponding to a different native code rate. The FEC encoder configured with the encoding configuration can be used to generate a set of parity bits corresponding to the set of shaped bits, the quantity of parity bits based on the threshold native code rate. A modulation symbol of the modulation scheme can be output corresponding to the set of shaped bits and the set of parity bits.

### INTRODUCTION

Aspects of the present disclosure generally relate to wireless communication. In some implementations, examples are described for probabilistic amplitude shaping (PAS) with a forward error correction (FEC) mother code rate implemented based on a modulation order.

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a network entity for wireless communication is provided. The network entity includes at a processing system, where the processing system is configured to: obtain a set of shaped bits encoded according to a probabilistic amplitude shaping (PAS) configuration for a modulation scheme, wherein a quantity of shaped bits in the set of shaped bits is based on a modulation order of the modulation scheme; determine a threshold native code rate for a forward error correction (FEC) encoder, wherein the threshold native code rate is determined based on the modulation order; obtain an encoding configuration for the FEC encoder, wherein the encoding configuration corresponds to the threshold native code rate, and wherein the encoding configuration is obtained from among a plurality of candidate encoding configurations corresponding to a respective plurality of native code rates; generate, using the FEC encoder configured with the encoding configuration, a set of parity bits corresponding to the set of shaped bits, wherein a quantity of parity bits in the set of parity bits is based on the threshold native code rate; and output a modulation symbol of the modulation scheme, the modulation symbol corresponding to the set of shaped bits and the set of parity bits.

In another example, a method for wireless communication is provided, the method including: obtaining a set of shaped bits encoded according to a probabilistic amplitude shaping (PAS) configuration for a modulation scheme, wherein a quantity of shaped bits in the set of shaped bits is based on a modulation order of the modulation scheme; determining a threshold native code rate for a forward error correction (FEC) encoder, wherein the threshold native code rate is determined based on the modulation order; obtaining an encoding configuration for the FEC encoder, wherein the encoding configuration corresponds to the threshold native code rate, and wherein the encoding configuration is obtained from among a plurality of candidate encoding configurations corresponding to a respective plurality of native code rates; generating, using the FEC encoder configured with the encoding configuration, a set of parity bits corresponding to the set of shaped bits, wherein a quantity of parity bits in the set of parity bits is based on the threshold native code rate; and outputting a modulation symbol of the modulation scheme, the modulation symbol corresponding to the set of shaped bits and the set of parity bits.

In another example, a non-transitory computer-readable storage medium comprising instructions stored thereon which, when executed by at least one processor, causes the at least one processor to: obtain a set of shaped bits encoded according to a probabilistic amplitude shaping (PAS) configuration for a modulation scheme, wherein a quantity of shaped bits in the set of shaped bits is based on a modulation order of the modulation scheme; determine a threshold native code rate for a forward error correction (FEC) encoder, wherein the threshold native code rate is determined based on the modulation order; obtain an encoding configuration for the FEC encoder, wherein the encoding configuration corresponds to the threshold native code rate, and wherein the encoding configuration is obtained from among a plurality of candidate encoding configurations corresponding to a respective plurality of native code rates; generate, using the FEC encoder configured with the encoding configuration, a set of parity bits corresponding to the set of shaped bits, wherein a quantity of parity bits in the set of parity bits is based on the threshold native code rate; and output a modulation symbol of the modulation scheme, the modulation symbol corresponding to the set of shaped bits and the set of parity bits.

In another example, an apparatus is provided for wireless communication. The apparatus includes: means for obtaining a set of shaped bits encoded according to a probabilistic amplitude shaping (PAS) configuration for a modulation scheme, wherein a quantity of shaped bits in the set of shaped bits is based on a modulation order of the modulation scheme; means for determining a threshold native code rate for a forward error correction (FEC) encoder, wherein the threshold native code rate is determined based on the modulation order; means for obtaining an encoding configuration for the FEC encoder, wherein the encoding configuration corresponds to the threshold native code rate, and wherein the encoding configuration is obtained from among a plurality of candidate encoding configurations corresponding to a respective plurality of native code rates; means for generating, using the FEC encoder configured with the encoding configuration, a set of parity bits corresponding to the set of shaped bits, wherein a quantity of parity bits in the set of parity bits is based on the threshold native code rate; and means for outputting a modulation symbol of the modulation scheme, the modulation symbol corresponding to the set of shaped bits and the set of parity bits.

In another illustrative example, a network entity for wireless communication is provided. The network entity includes at a processing system, where the processing system is configured to: receive a transmission including a modulation symbol corresponding to a set of shaped bits and a set of parity bits encoded according to a probabilistic amplitude shaping (PAS) configuration for a modulation scheme, wherein a quantity of shaped bits in the set of shaped bits is based on a modulation order of the modulation scheme; determine a threshold native code rate for a forward error correction (FEC) decoder, wherein the threshold native code rate is determined based on the modulation order; obtain a decoding configuration for the FEC decoder, wherein the decoding configuration corresponds to the threshold native code rate, and wherein the decoding configuration is obtained from among a plurality of candidate decoding configurations corresponding to a respective plurality of native code rates; determine, using the FEC decoder configured with the decoding configuration, parity check information corresponding to at least one of the modulation symbol or the set of parity bits, wherein a quantity of parity bits in the set of parity bits is based on the threshold native code rate; and decode the modulation symbol from the transmission and the parity check information, the modulation symbol corresponding to the set of shaped bits and the set of parity bits.

In another example, a method for wireless communication is provided, the method including: receiving a transmission including a modulation symbol corresponding to a set of shaped bits and a set of parity bits encoded according to a probabilistic amplitude shaping (PAS) configuration for a modulation scheme, wherein a quantity of shaped bits in the set of shaped bits is based on a modulation order of the modulation scheme; determining a threshold native code rate for a forward error correction (FEC) decoder, wherein the threshold native code rate is determined based on the modulation order; obtaining a decoding configuration for the FEC decoder, wherein the decoding configuration corresponds to the threshold native code rate, and wherein the decoding configuration is obtained from among a plurality of candidate decoding configurations corresponding to a respective plurality of native code rates; determining, using the FEC decoder configured with the decoding configuration, parity check information corresponding to at least one of the modulation symbol or the set of parity bits, wherein a quantity of parity bits in the set of parity bits is based on the threshold native code rate; and decoding the modulation symbol from the transmission and the parity check information, the modulation symbol corresponding to the set of shaped bits and the set of parity bits.

In another example, a non-transitory computer-readable storage medium comprising instructions stored thereon which, when executed by at least one processor, causes the at least one processor to: receive a transmission including a modulation symbol corresponding to a set of shaped bits and a set of parity bits encoded according to a probabilistic amplitude shaping (PAS) configuration for a modulation scheme, wherein a quantity of shaped bits in the set of shaped bits is based on a modulation order of the modulation scheme; determine a threshold native code rate for a forward error correction (FEC) decoder, wherein the threshold native code rate is determined based on the modulation order; obtain a decoding configuration for the FEC decoder, wherein the decoding configuration corresponds to the threshold native code rate, and wherein the decoding configuration is obtained from among a plurality of candidate decoding configurations corresponding to a respective plurality of native code rates; determine, using the FEC decoder configured with the decoding configuration, parity check information corresponding to at least one of the modulation symbol or the set of parity bits, wherein a quantity of parity bits in the set of parity bits is based on the threshold native code rate; and decode the modulation symbol from the transmission and the parity check information, the modulation symbol corresponding to the set of shaped bits and the set of parity bits.

In another example, an apparatus is provided for wireless communication. The apparatus includes: means for receiving a transmission including a modulation symbol corresponding to a set of shaped bits and a set of parity bits encoded according to a probabilistic amplitude shaping (PAS) configuration for a modulation scheme, wherein a quantity of shaped bits in the set of shaped bits is based on a modulation order of the modulation scheme; means for determining a threshold native code rate for a forward error correction (FEC) decoder, wherein the threshold native code rate is determined based on the modulation order; means for obtaining a decoding configuration for the FEC decoder, wherein the decoding configuration corresponds to the threshold native code rate, and wherein the decoding configuration is obtained from among a plurality of candidate decoding configurations corresponding to a respective plurality of native code rates; means for determining, using the FEC decoder configured with the decoding configuration, parity check information corresponding to at least one of the modulation symbol or the set of parity bits, wherein a quantity of parity bits in the set of parity bits is based on the threshold native code rate; and means for decoding the modulation symbol from the transmission and the parity check information, the modulation symbol corresponding to the set of shaped bits and the set of parity bits.

Aspects generally include a method, apparatus, system, computer program product, non-transitory computer-readable medium, user equipment, base station, wireless communication device, and/or processing system as substantially described herein with reference to and as illustrated by the drawings and specification. The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of a non-uniform distribution of constellation point probabilities corresponding to a distribution matcher for amplitude shaping, in accordance with some examples;

FIG. 6 is a block diagram of a probabilistic amplitude shaping (PAS)-based transmitter system including a distribution matcher and a forward error correction (FEC) encoder with an FEC code rate configured based on a modulation order associated with a transmission, in accordance with some examples;

FIG. 7 is a flow diagram illustrating an example of a process for wireless communication, in accordance with some examples;

FIG. 8 is a flow diagram illustrating another example of a process for wireless communication, in accordance with some examples; and

FIG. 9 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

A wireless device (e.g., such as a user equipment (UE) and/or network entity (e.g., base station, gNB, etc.)) may perform amplitude shaping to shape a constellation diagram of a modulation scheme during modulation of a bit sequence. Amplitude shaping can be used to improve the efficiency of wireless data transmission based on reducing the average power of the transmitted signal while maintaining error performance. In some cases, amplitude shaping of a bit sequence can include shaping the bit sequence or corresponding symbols to alter the distribution of transmitted symbols (e.g., based on the constellation diagram of the modulation scheme, etc.). An example of amplitude shaping is probabilistic amplitude shaping (PAS), which can be used to map a constellation over a non-uniform probabilistic distribution. For example, PAS can apply amplitude shaping to the respective bits associated with a symbol in a constellation diagram of a modulation scheme, where the amplitude of each respective bit is shaped according to a configured probability density function (PDF) or other probability distribution, etc.

Amplitude shaping techniques (e.g., such as PAS) applied to a bit sequence can further include the coding of redundancy information, such as parity bits, error correction bits, forward error correction (FEC) bits, etc. For example, amplitude shaping (e.g., PAS) can be applied for an input bit sequence of uniformly arriving bits, to generate a set of shaped bits (e.g., distributed according to the configured PDF or other distribution configured for the PAS) and a set of non-shaped bits (e.g., still distributed according to the uniform arrival sequence). Redundancy information, error correction, FEC, etc., can be determined after applying PAS, for example by determining the redundancy bits, error correction bits, FEC bits, etc., for the set of shaped bits output from the PAS encoder.

In some examples, a PAS transmission scheme can be implemented using a PAS encoder and a FEC encoder. The PAS encoder can use a distribution matcher (DM) to shape modulated amplitudes (e.g., modulated amplitudes according to the modulation scheme, for example Quadrature Amplitude Modulation (QAM) amplitudes according to a QAM modulation scheme, etc.) based on the configured PDF associated with the distribution matcher and/or associated with the PAS encoder. The shaped amplitudes can be translated to Gray bits, based on a corresponding Gray mapping performed by or for the PAS transmission scheme. The Gray bits can be provided as input to the FEC encoder of the PAS transmission scheme, where the input Gray bits are shaped systematic bits preserved to the output of the FEC encoder for subsequent mapping to QAM amplitudes by a symbol mapper. A code rate of the FEC encoder can correspond to the number of non-shaped systematic bits and the number of parity check bits that the FEC encoder generates as output along with the shaped systematic bits noted above. For example, the code rate of the FEC encoder can be determined as (total systematic bits)/(total bits)=(shaped systematic bits+non-shaped systematic bits)/(shaped systematic bits+non-shaped systematic bits+parity bits).

In a PAS transmission scheme, the code rate of the FEC encoder may be adjusted based on the configuration of the PAS encoder that is applied prior to the FEC encoder. For example, the distribution matcher of the PAS encoder may introduce an overhead corresponding to the difference between the average input length to the distribution matcher and the average output length of the distribution matcher. This difference between average input and output length at the distribution matcher can be referred to as a DM overhead. In some examples, increases to the DM overhead may correspond to the PAS transmission scheme implementing a compensation by decreasing the FEC overhead. Decreasing the FEC overhead can correspond to weakening the code rate of the FEC encoder (e.g., increasing the code rate to a value closer to 1, for example by removing parity or redundancy bits).

For higher order modulations and modulation schemes, the FEC encoder may be forced to relatively high code rates to decrease the FEC overhead in compensation for larger DM overheads associated with the higher order modulations and modulation schemes that may be implemented in the PAS transmission scheme. High code rates of the FEC encoder can correspond to heavy puncturing being performed by the FEC encoder to achieve the requisite high code rate. Heavy puncturing by the FEC encoder can correspond to significant performance degradation relative to a FEC encoder that has the same code rate as its native (e.g., mother) code rate with little to no puncturing. The heavy puncturing by the FEC encoder can cause the FEC encoder to operate beyond its maximum puncturing threshold, which causes the code to completely collapse (e.g., for NR LDPC, the maximum puncturing threshold before code collapse may be given as the set of code rates r≥0.930). There is a need for systems and techniques that can be used to implement FEC encoders for a PAS transmission scheme with reduced puncturing by the FEC encoder. There is a further need for systems and techniques that can be used to provide a PAS transmission scheme with a FEC encoder that can be configured with a different FEC mother code rate (e.g., a different FEC native code rate) per modulation scheme and/or modulation order of the PAS encoder included in the PAS transmission scheme.

Systems, apparatuses, processes (also referred to as methods), and computer-readable media (collectively referred to as “systems and techniques”) are described herein that can be used to provide probabilistic amplitude shaping (PAS) with a forward error correction (FEC) encoder code rate based on a modulation order corresponding to a PAS encoder. For example, the FEC encoder can be configured with and/or can implement a code rate that is based on a modulation order of a modulation scheme implemented by a PAS encoder, where the PAS encoder and the FEC encoder are included in a PAS transmission scheme. In some aspects, the FEC encoder can be configured with a respective native code rate per modulation order and/or per modulation scheme that may be implemented by the PAS encoder. For example, increasing the modulation order associated with the PAS encoder and/or the PAS transmission scheme that includes the FEC encoder can correspond to configuring the FEC encoder to implement a higher native code rate (e.g., a native code rate with a value closer to the maximum code rate of 1). Decreasing the modulation order associated with the PAS encoder and/or the PAS transmission scheme can correspond to configuring the FEC encoder to implement a lower native code rate (e.g., a native code rate with a value farther from the maximum code rate of 1). Based on configuring the FEC encoder of a PAS transmission scheme to use a different native code rate configuration based on the PAS modulation order and/or modulation scheme, the systems and techniques can be used to reduce puncturing of the error correcting code (e.g., can be used to reduce puncturing of the encoded output of the FEC encoder, etc.).

A native code rate can also be referred to as a “mother code rate,” for example the native code rate of the FEC encoder may also be referred to as the mother code rate of the FEC encoder. A native code rate (e.g., mother code rate) can refer to the fundamental rate of an error-correcting code, before any modifications such as puncturing or other rate matching techniques are applied. For example, the native or mother code rate of an encoder is the intrinsic rate at which the encoder produces coded bits, independent of additional rate adaptation techniques that may be applied. For example, the native (e.g., mother) code rate of the FEC encoder can be the code rate of the FEC encoder without performing puncturing or other rate matching techniques to increase or decrease the effective code rate associated with the output of the FEC encoder. Puncturing is a rate matching technique that can be used to increase the effective code rate by selectively removing (e.g., puncturing) particular bits from the encoded output of a lower-rate code to create a higher-rate code. For example, puncturing that removes error-correcting or parity bits from the encoded output of a FEC encoder can be used to increase the effective rate of the FEC encoder, based on code rate being determined as the ratio between the number of information (e.g., systematic) bits transmitted to the total number of bits (e.g., systematic+parity bits) that are transmitted. In some examples, the native (e.g., mother) code rate of a FEC encoder is the code rate without puncturing to remove one or more parity bits from the encoded output of the FEC encoder.

In some cases, the systems and techniques can be used to provide mother code rates for forward error correction in a PAS transmission scheme and/or a PAS reception scheme, where a respective FEC encoder of the PAS transmission scheme and/or a respective FEC decoder of the PAS reception scheme can be configured to use a selected mother code rate (e.g., native code rate) that is optimized for the modulation order and/or modulation scheme (e.g., modulation coding scheme (MCS)) of the PAS transmission or reception scheme. For example, a FEC encoder or FEC decoder can be configured with multiple codes with different native (e.g., mother) code rates, where the FEC encoder or decoder selects a particular code rate from the multiple code rates to implement FEC coding with a native code rate based on the modulation order of the modulation scheme implemented by the PAS transmission or reception scheme.

In some aspects, the multiple mother code rates that can be implemented for the FEC may each correspond to a different, respective configuration of the FEC encoder or FEC decoder. For example, a respective configuration for the FEC encoder or decoder can be implemented according to a corresponding parity check matrix H^{T} and/or a corresponding inverse parity check matrix (H⁻¹)^{T}. The respective native (e.g., mother) code rate configured for the FEC encoder or FEC decoder can be based on the dimensions of the respective parity check matrix H^{T} or inverse parity check matrix (H⁻¹)^{T} of the configuration. In one illustrative example, the systems and techniques can provide a FEC coding configuration that can be used to reduce puncturing in a PAS coding system or PAS coding scheme, based on the FEC coding configuration including multiple codes with different native rates of the form

$$\frac{m - 1}{m} ,$$

where the term m represents a value corresponding to the modulation order and/or modulation scheme implemented by the PAS coding scheme. For example, the term m can be related to the modulation order of the PAS coding scheme as modulation order=2·m, where m=½ (modulation order). In some aspects, the FEC encoder or decoder can implement multiple different codes with native rates of the form

$$\frac{m - 1}{m} ,$$

where 2·m is equal to the modulation order associated with the respective PAS encoder or decoder corresponding to the FEC encoder or decoder in the PAS coding system or PAS coding scheme.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, a processing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, processing system, or the like may include disclosure of the UE, base station, apparatus, device, computing system, processing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first processing system, a first one or more components, a first processing entity, or the like configured to receive the information; and the second network node may refer to a second UE, a second base station, a second apparatus, a second device, a second computing system, a second processing system, a second one or more components, a second processing entity, or the like.

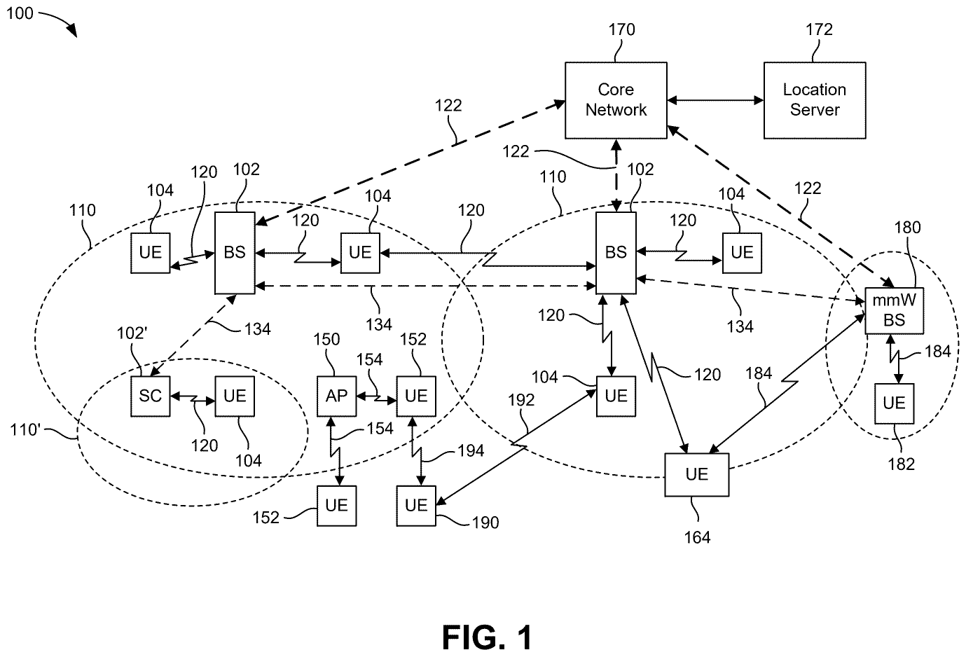

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, a processing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network illustrated by the wireless communication system 100 of FIG. 1. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, network node, apparatus, device, computing system, processing system or the like may include disclosure of the UE, base station, network node, apparatus, device, computing system, processing system or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first processing system, a first set of one or more one or more components, a first processing entity, or the like configured to receive the information; and the second network entity may refer to a second UE, a second base station, a second apparatus, a second device, a second computing system, a second processing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

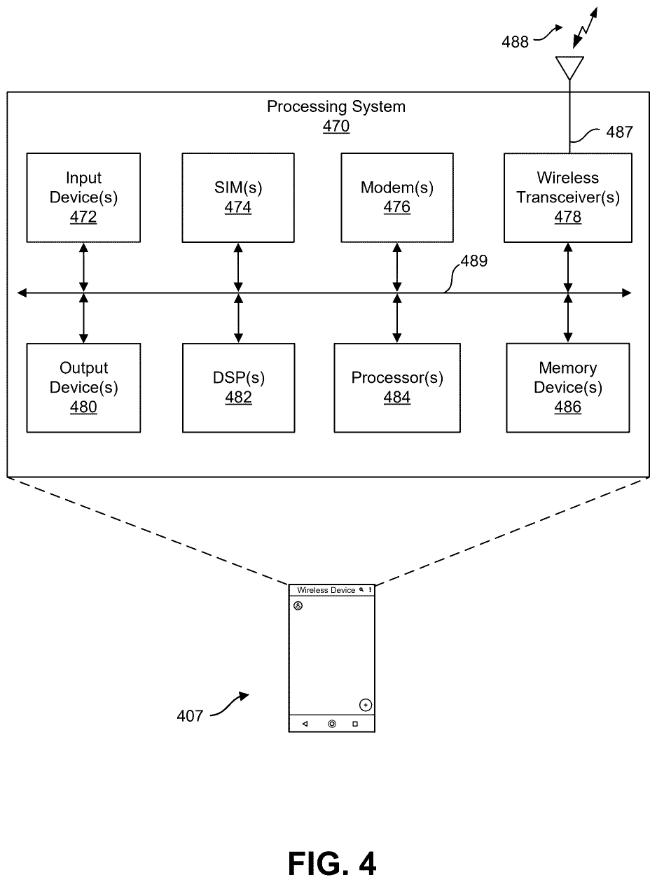

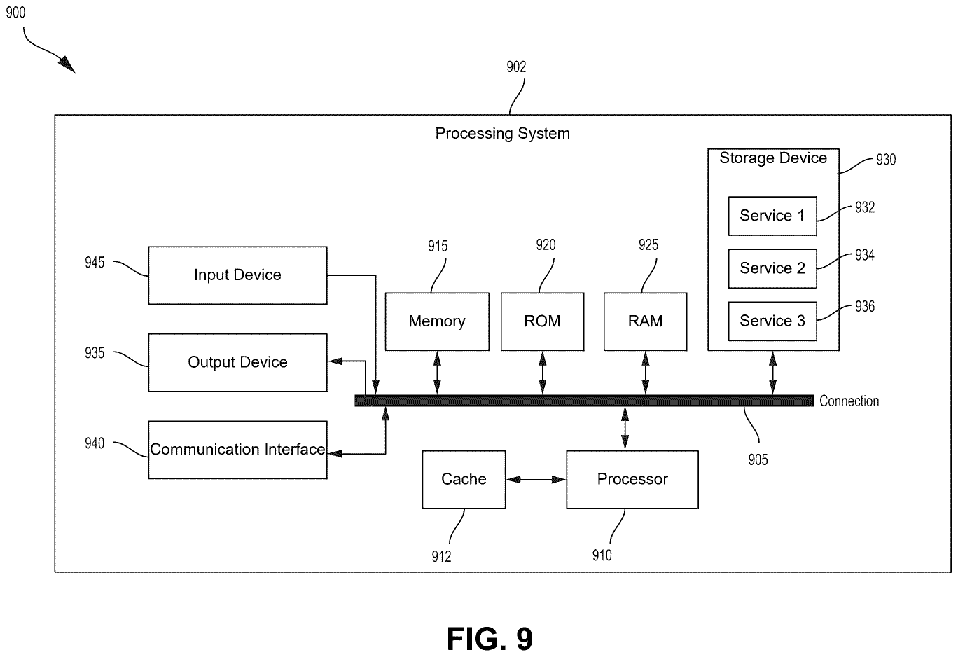

In some examples, the network entity 102 may include a processing system (e.g., such as the processing system 470 of FIG. 4 and/or the processing system 902 of FIG. 9, etc.). Similarly, the network entity 180 (e.g., a millimeter wave (mmW) base station, etc.) may include a respective processing system (e.g., such as the processing system 470 of FIG. 4 and/or the processing system 902 of FIG. 9, etc.). A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that May perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 102 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction.

The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

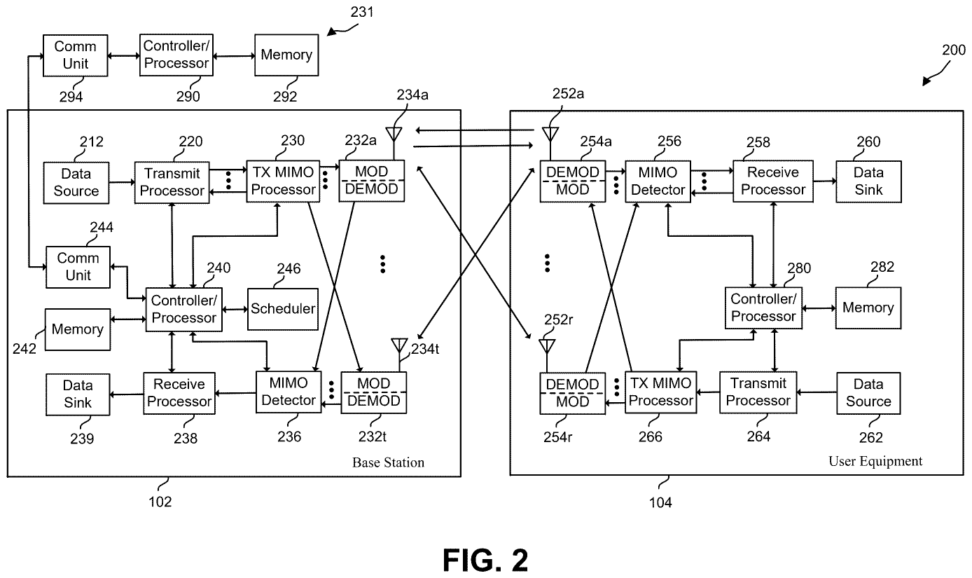

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit Uplink Control Information (UCI) beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations May be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

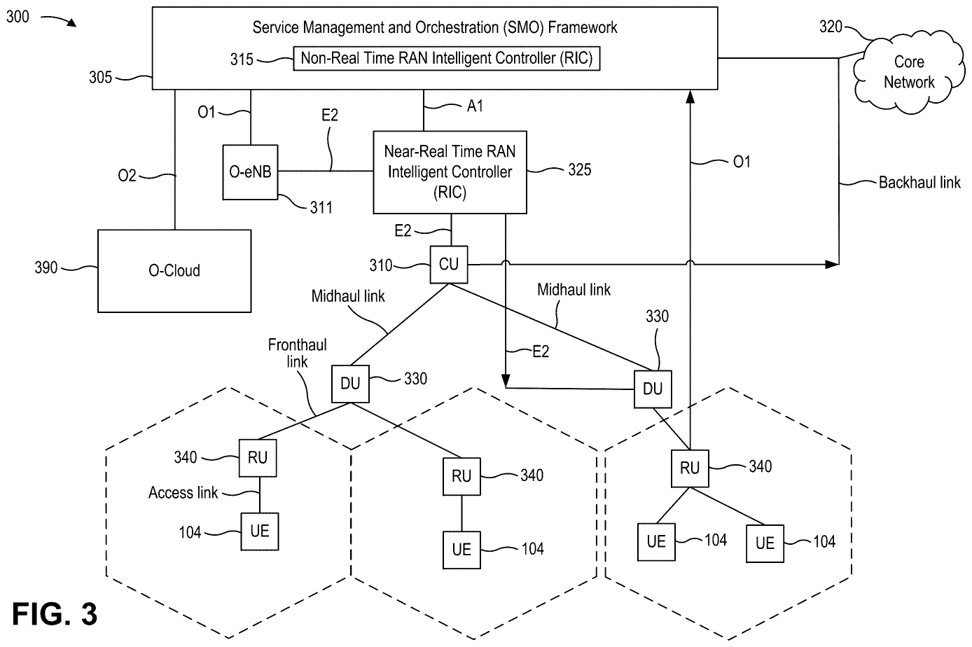

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUS 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via O1) or via creation of RAN management policies (e.g., such as A1 policies).

FIG. 4 illustrates an example of a processing system 470 of a wireless device 407. In some examples, the processing system 470 may also be referred to as a computing system. The processing system 470 may include and/or implement one or more components that are the same as or similar to respective components included in and/or implemented by the processing system 902 of FIG. 9 (e.g., and the processing system 902 of FIG. 9 may include and/or implement one or more components that are the same as or similar to respective components included in and/or implemented by the processing system 470 of FIG. 4). In some cases, the wireless device 407 may also be referred to as a user computing device. The wireless device 407 may include a client device such as a UE (e.g., UE 104, UE 152, UE 190) or other type of device (e.g., a station (STA) configured to communication using a Wi-Fi interface) that may be used by an end-user. In some cases, the processing system 470 of the wireless device 407 can be implemented by one or more of the UEs 104 of FIG. 1. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network.

The processing system 470 includes software and hardware components that may be electrically or communicatively coupled via a bus 489 (e.g., or may otherwise be in communication, as appropriate). The processing system 470 may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. For example, the processing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The processing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, processing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the processing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the processing system 470 may include a coding-decoding device (or CODEC) configured to encode and/or decode data transmitted and/or received using the one or more wireless transceivers 478. In some cases, the processing system 470 may include an encryption-decryption device or component configured to encrypt and/or decrypt data (e.g., according to the Advanced Encryption Standard (AES) and/or Data Encryption Standard (DES) standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The processing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The processing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

As noted above, systems and techniques are described herein that can be used to provide probabilistic amplitude shaping (PAS) with forward error correction (FEC), where a code rate associated with the FEC is based on a modulation order of the PAS modulation. For example, in some aspects the systems and techniques can be used to implement multiple native code rates for a FEC encoder and/or decoder, where the FEC native code rate is configured according to a modulation order of the PAS modulation. In some cases, increasing the modulation order of the PAS modulation can cause the systems and techniques to increase the native code rate (e.g., also referred to as the mother code rate) of the FEC. Increasing the native code rate can correspond to weakening the code rate of the FEC, for example by setting the native code rate to a value closer to 1 (e.g., reducing the parity or error correction bits included in the encoded bits output by a FEC encoder, etc.).

In some examples, a wireless device (e.g., a UE, a network entity (e.g., base station, gNB, etc.), etc.) may perform amplitude shaping to shape a constellation diagram of a modulation scheme, during modulation of a bit sequence. Amplitude shaping can be used to improve the efficiency of wireless data transmission based on reducing the average power of the transmitted signal while maintaining error performance, based on shaping to shape the bit sequence to alter the distribution of transmitted symbols. An example of amplitude shaping is probabilistic amplitude shaping (PAS), which can be used to map a constellation over a non-uniform probabilistic distribution. For example, PAS can apply amplitude shaping to the respective bits associated with a symbol in a constellation diagram of a modulation scheme, where the amplitude of each respective bit is shaped according to a configured probability density function (PDF) or other probability distribution, etc.

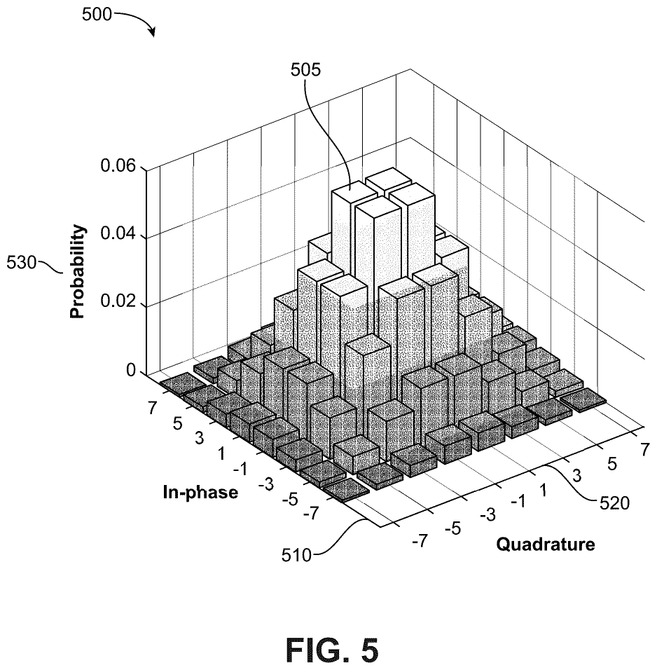

For example, FIG. 5 is a diagram illustrating an example of a non-uniform distribution 500 of constellation point probabilities corresponding to a distribution matcher for amplitude shaping, in accordance with some examples. In one illustrative example, the non-uniform distribution 500 can be a probability distribution (also referred to as a probabilistic distribution, etc.) that can be used in a PAS coding system and/or PAS coding scheme to perform probabilistic shaping of bit amplitudes according to the distribution 500. For example, an amplitude shaping encoder configured to perform amplitude shaping for an input bit sequence according to the probabilistic distribution 500 can be referred to as a PAS encoder. The amplitude shaping applied by a PAS encoder can be based on a respective probability value along a probability axis 530 indicated by the non-uniform probabilistic distribution 500 for each respective input bit. In some aspects, the probabilistic distribution 500 is a non-uniform distribution that maps different probability values (e.g., corresponding to the probability axis 530 of the distribution) to corresponding combinations of in-phase (I) and quadrature (Q) component values, associated with the In-phase axis 510 and the Quadrature-phase axis 520, respectively.

In some aspects, the non-uniform probabilistic distribution 500 can be used to shape a constellation diagram of a modulation scheme, based on mapping the points of the constellation (e.g., such as a QAM constellation, Amplitude Phase Shift Keying (APSK) constellation, or various other constellations corresponding to a modulation or modulation scheme associated with the PAS coding system, etc.) over the non-uniform probabilistic distribution of probability values along the probability axis 530. For example, different constellation points may be identified according to their respective in-phase 510 and quadrature-phase 520 values, with the I/Q components for a respective constellation point being used as inputs to the probabilistic distribution 500 to obtain a corresponding probability value (from the values along the probability axis 530) to be applied for the probabilistic amplitude shaping. In some cases, a PAS encoder can use a probability density function (PDF) and/or the non-uniform probabilistic distribution 500 to shape the constellation diagram (e.g., to shape the set of constellation points corresponding to symbols of the modulation scheme applied by the PAS encoder) during the modulation of an input bit sequence for transmission. The PAS encoder can use the distribution 500 to perform amplitude shaping to adjust the probability distribution of the shaped bits to match or correspond to the probability distribution 500 configured for the PAS encoder. For example, the adjusted shape or distribution of the transmitted signal's constellation points after shaping according to the distribution 500 can be used to minimize or reduce the average power associated with performing the transmission.

In some examples, probabilistic amplitude shaping (e.g., a PAS coding system, PAS transmission scheme, PAS reception scheme, PAS encoder, PAS decoder, etc.) can be implemented based on the Gaussian probabilistic distribution as the capacity-achieving distribution for a continuous source. For a discrete source (e.g., QAM, APSK, etc.) such as a sequence of separately arriving bits included in an input sequence to the PAS encoder, etc., the capacity-achieving distribution can be modified slightly from the Gaussian probabilistic distribution to instead be the Maxwell-Boltzmann distribution. For example, FIG. 5 illustrates the non-uniform probabilistic distribution 500, which can be an example of a Maxwell-Boltzmann distribution, which is a distribution that may follow a Gaussian bell shape Pₓ(x)=ke^{-v|x|}^{²}. The Maxwell-Boltzmann distribution used as the non-uniform probabilistic distribution 500 for a discrete source can be implemented to maximize a discrete source's entropy, in a manner the same as or similar to the entropy maximization of a Gaussian distribution over a continuous source.

In a Gaussian distribution and/or a Maxwell-Boltzmann distribution, inner constellation points (e.g., nearer to the [0,0] origin of the plane comprising the in-phase axis 510 and the quadrature-phase axis 520) are assigned with a higher probability of use. Assigning a higher probability of use for the inner constellation points in the non-uniform probabilistic distribution 500 corresponds to mapping the constellation points near the origin of the I/Q axes 510 and 520 to have larger (e.g., higher) probabilities along the probability axis 530 of the probabilistic distribution 500. For example, the four constellation points 505 in FIG. 5 are the highest probability constellation points for the distribution 500, corresponding to mapping the constellation points [1,1], [1,−1], [−1, 1], and [−1,−1] along the I/Q axes 510, 520 to the highest probability value (e.g., the maximum probability value of approximately 0.04 that is used within the distribution 500) along the probability axis 530.

PAS transmission schemes can perform amplitude shaping to achieve a configured non-uniform distribution (e.g., such as the probabilistic distribution 500, etc.) of bits before providing the shaped bits as input to a constellation mapper including in the transmitter. For example, the output of a PAS encoder can be a set of shaped bits and a set of non-shaped bits, with a shaping rate given by the number of inputs bits that are shaped per output symbol that is transmitted (e.g., per modulation symbol of the PAS transmission scheme). For example, the shaping rate of the PAS encoder can be determined as k/n, where k represents the message length (e.g., the number of input bits to the PAS encoder) and n represents the codeword length (e.g., the number of output bits per symbol). Higher shaping rates can correspond to relatively low redundancy, and lower shaping rates can correspond to relatively high redundancy.

In some aspects, the probabilistic shaping operation associated with a PAS encoder can be implemented by a distribution matcher (DM), which can be configured to perform shaping of amplitude probabilities while maintaining the sign (e.g., positive or negative I/Q) as uniformly distributed for the input bits and the amplitude shaped bits generated as output. For example, the DM can be configured to shape the amplitudes of a uniformly arriving input bit sequence to generate an output of amplitude shaped bits with amplitude probabilities shaped corresponding to the probabilistic distribution 500 (e.g., or other configured probabilistic distribution for the PAS operations of the DM and/or PAS encoder that includes the DM, etc.), and with uniform sign probabilities (e.g., 0.5 probability for positive/negative sign).

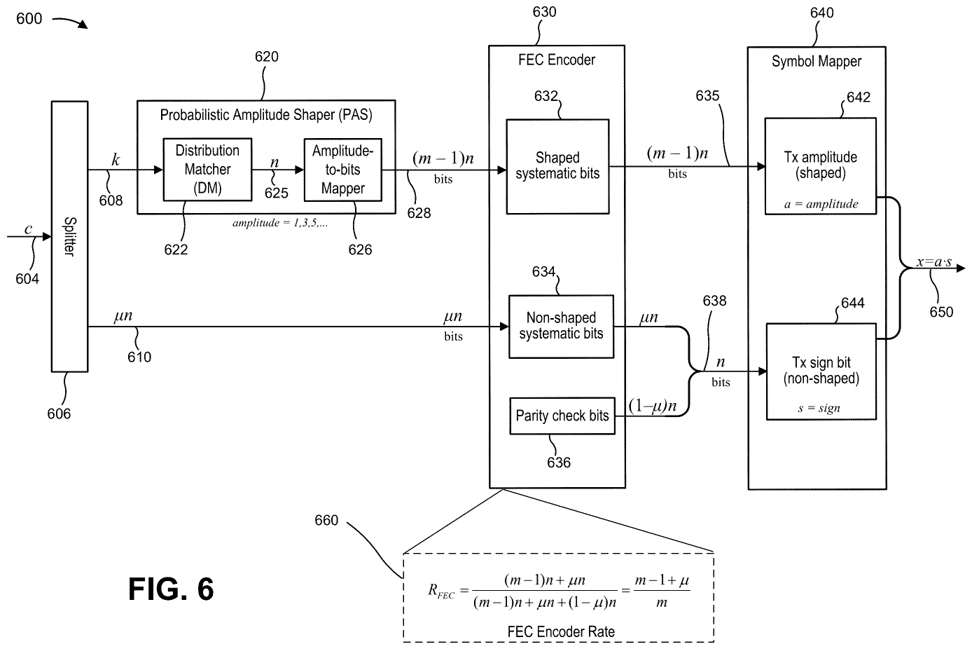

For example, FIG. 6 is a block diagram of a probabilistic amplitude shaping (PAS)-based transmitter system 600 including a probabilistic amplitude shaper (PAS) encoder 620 and a forward error correction (FEC) encoder 630, in accordance with some examples. In some aspects, the PAS-based transmitter system 600 can also be referred to as a PAS transmission scheme. A PAS transmission scheme can refer to a coding system including at least a PAS encoder (e.g., such as PAS encoder 620) and a FEC encoder (e.g., such as FEC encoder 630) configured to receive one or more shaped bits from the output of the PAS encoder.

In some examples, the PAS encoder 620 can include a distribution matcher 622, that can be used to perform amplitude shaping by applying a probability distribution (e.g., such as non-uniform distribution 500 of FIG. 5, etc.) to a uniformly arriving input sequence of bits k 608. The output of the distribution matcher 622 can be the n shaped amplitudes 625, for example where n corresponds to the number of different amplitudes that are shaped or included in the constellation diagram. The PAS encoder 620 can include an amplitude-to-bits mapper 626, which maps the shaped amplitudes n 625 to the set of shaped bits (m−1)n 628 (e.g., systematic shaped bits) generated as output by the PAS encoder 620. For example, the set of shaped bits 628 can comprise the set of (m−1)n shaped systematic bits generated for the input sequence of bits k 608 provided to the DM 622 of the PAS encoder 620.

In some aspects, the input sequence of bits k 608 can be obtained based on the PAS transmitter system 600 using a splitter 606 to demultiplex or split an input sequence c of bits 604 into a first quantity or subset of bits k 608, and a second quantity or subset of bits μn 610. In some examples, the splitter 606 can be a demultiplexer, and can divide the input sequence c of bits 604 into a quantity of most significant bits (MSBs) 608 (e.g., k) and a quantity of least significant bits (LSBs) 610 (e.g., un). The splitter 606 can be used to divide the input sequence c of bits 604 into the first and second quantities 608, 610 according to various other criteria or parameters as well.

The output of the PAS encoder 620 can be the same as the output of the amplitude-to-bits mapper 626, and can comprise the set of systematic (e.g., information-bearing, etc.) shaped bits 628 (e.g., (m−1)n bits). Each constellation point (e.g., modulation symbol) within the constellation diagram for the modulation or modulation scheme implemented by the PAS encoder 620 and/or PAS transmitter system 600 can be represented by a respective m-bit set. For example, the respective m-bit set for each constellation point can include (m−1) bits of shaped amplitude information (e.g., (m−1) bits of amplitude per I/Q). Each set of (m−1) bits of shaped amplitude per I/Q (e.g., per constellation point) can be associated with one sign bit.

The set of shaped systematic bits 628 generated as output by the distribution matcher 622 of the PAS encoder 620 can include the (m−1) shaped amplitude bits for each constellation point, multiplied by the number of constellation points n (e.g., the set of shaped systematic bits 628 includes a total of (m−1)n systematic bits that are amplitude shaped for the n constellation points of the modulation's constellation diagram).

The (m−1)n shaped systematic bits can be provided from the PAS encoder 620 to the FEC encoder 630, as the set of shaped systematic bits 632 (e.g., shaped bits). For example, the set of shaped systematic bits 632 used by the FEC encoder 630 can be the same as the (m−1)n shaped bits 628 output form the PAS encoder 620.

The quantity of un-shaped (e.g., non-shaped) bits μn 610 obtained based on the splitter 606 dividing or demultiplexing the input sequence of bits c 604, can be provided as additional input to the FEC encoder 630, bypassing the PAS encoder 620. For example, the FEC encoder 630 can receive an additional input comprising the set of non-shaped systematic bits 634 for the input sequence c 604, where the set of non-shaped systematic bits 634 is the same as the quantity of un-shaped (e.g., non-shaped) bits μn 610 output by the splitter 606 after dividing or demultiplexing the input bit sequence c 604. For example, the splitter 606 can output the set of non-shaped systematic bits 610 (e.g., the same as the FEC encoder 630 input of non-shaped systematic bits 634) to include a respective quantity u of non-shaped systematic bits for each constellation point n, for a total of un non-shaped systematic bits 634 (e.g., the same as the non-shaped bits 610). In some cases, the value of u can be a configurable parameter of the PAS transmitter system 600, and may be used to adjust the overhead of the FEC encoder 630.

In some cases, the distribution matcher 622 of the PAS encoder 620 can be used to shape the amplitudes of the input bits k 608 to match a configured probability density function (PDF) or other probabilistic distribution (e.g., such as the non-uniform probabilistic distribution 500 of FIG. 5, etc.) configured for the PAS transmitter system 600 and/or the DM 622. For example, the DM 622 may shape the QAM amplitudes of a corresponding input set of bits k 608 to match a configured PDF as shown in the example of Table 1, below:

TABLE 1
Example shaping by a PAS distribution matcher using Huffman
coding (e.g., variable length codes based on frequency of
occurrence), where the I/Q of an example 256QAM modulation with
a modulation order of 2^{m} = 8 (e.g., m = 4) is
shaped corresponding to greater probabilities for lower
amplitudes. Adjacent Euclidean constellation points may
be assigned using Gray mapping to minimize the error.

| Input | I/Q amplitude | | Output |
|---|---|---|---|
| k | n | Probability | (m−1) · n |
| 00 | 1 | 1/4 | 100 |
| 01 | 3 | 1/4 | 101 |
| 110 | 5 | 1/8 | 111 |
| 101 | 7 | 1/8 | 110 |
| 1100 | 9 | 1/16 | 010 |
| 1101 | 11 | 1/16 | 011 |
| 1110 | 13 | 1/16 | 001 |
| 1111 | 15 | 1/16 | 000 |

In some aspects, the set of amplitudes n 625 corresponding to the output of the distribution matcher 622 included in the PAS encoder 620 of FIG. 6 can correspond to the I/Q amplitude values n shown in the second column of Table 1, above. For example, according to the PDF of Table 1, the DM 622 can perform probabilistic shaping using Huffman coding to shape inputs k to probabilistic outputs (m−1)·n, where the Huffman coding is implemented as a variable length code with greater frequencies of occurrence mapped to shorter code lengths, and lesser frequencies of occurrence mapped to longer code lengths.

For example, for an input bit sequence k 604 of ‘00’, the DM 622 can use the PDF of Table 1 to apply the shaped I/Q amplitude n=1, with a probability of ¼ (e.g., 0.25), with a corresponding coded output of ‘100.’ The input code length=2, and the output code length=3.

In another example, for an input bit sequence k 604 of ‘01’, the DM 622 can use the PDF of Table 1 to apply the shaped I/Q amplitude n=3, with a probability of ¼ (e.g., 0.25), with a corresponding coded output of ‘101.’ The input code length=2, and the output code length=3. The cumulative probability for the first two rows is equal to 0.5.

The third row of Table 1 corresponds to the example of an input bit sequence k 604 of ‘110’, for which the DM 622 can use the PDF of Table 1 to apply the shaped I/Q amplitude n=5, with a probability of ⅛ (e.g., 0.125), and with a corresponding coded output of ‘111.’ The input code length=3, and the output code length=3. The cumulative probability for the first three rows is equal to 0.625.

The fourth row of Table 1 corresponds to the example of an input bit sequence k 604 of ‘101’, for which the DM 622 can use the PDF of Table 1 to apply the shaped I/Q amplitude n=7, with a probability of ⅛ (e.g., 0.125), and with a corresponding coded output of ‘110.’ The input code length=3, and the output code length=3. The cumulative probability for the first four rows is equal to 0.75.

The fifth row of Table 1 corresponds to the example of an input bit sequence k 604 of ‘1100’, for which the DM 622 can use the PDF of Table 1 to apply the shaped I/Q amplitude n=9, with a probability of 1/16 (e.g., 0.0625), and with a corresponding coded output of ‘010.’ The input code length=4, and the output code length=3. The cumulative probability for the first five rows is equal to 0.8125.

The sixth row of Table 1 corresponds to the example of an input bit sequence k 604 of ‘1101’, for which the DM 622 can use the PDF of Table 1 to apply the shaped I/Q amplitude n=11, with a probability of 1/16 (e.g., 0.0625), and with a corresponding coded output of ‘011.’ The input code length=4, and the output code length=3. The cumulative probability for the first six rows is equal to 0.875.

The seventh row of Table 1 corresponds to the example of an input bit sequence k 604 of ‘1110’, for which the DM 622 can use the PDF of Table 1 to apply the shaped I/Q amplitude n=13, with a probability of 1/16 (e.g., 0.0625), and with a corresponding coded output of ‘001.’ The input code length=4, and the output code length=3. The cumulative probability for the first seven rows is equal to 0.9375.

The eighth row of Table 1 corresponds to the example of an input bit sequence k 604 of ‘1111’, for which the DM 622 can use the PDF of Table 1 to apply the shaped I/Q amplitude n=15, with a probability of 1/16 (e.g., 0.0625), and with a corresponding coded output of ‘000.’ The input code length=4, and the output code length=3. The cumulative probability for the first eight rows is equal to 1.

In one illustrative example, the shaped systematic bits 632 provided to the FEC encoder 630 (e.g., the (m−1)n shaped bits 628 generated as the output from the amplitude-to-bits mapper 626 of the PAS encoder 620) can be the same as or similar to the (m−1)n bits represented in the output column of Table 1. In some aspects, the shaped amplitudes n 625 output by the DM 622 can be translated to Gray bits by the amplitude-to-bits mapper 626 of the PAS encoder 620, where the input to the amplitude-to-bits mapper 626 is the same as the output of the DM 622 (e.g., the shaped amplitude n 625). In some cases, the output of the amplitude-to-bits mapper 626 is the Gray-labeled shaped systematic bits (m−1)n 628, which fed the FEC encoder 630 input as the shaped systematic bits 632, as noted above.

The shaped systematic bits 632 provided from the PAS encoder 620 to the input of the FEC encoder 630 may be preserved as is to the output 635 of the FEC encoder 630. For example, the shaped systematic bits 632 of the FEC encoder 630 may be the same at the input of the FEC encoder 630 (e.g., the input (m−1)n shaped systematic bits 628) as they are at the output 635 of the FEC encoder 630 (E.g., the output 635 comprising (m−1)n shaped systematic bits).

The (m−1)n shaped systematic bits 628 can be the same at the output of the PAS encoder 620/input of the FEC encoder 630, within the FEC encoder 630 as the shaped systematic bits 632, and at the output 635 of the FEC encoder 630/input to the symbol mapper 640. In some aspects, the symbol mapper 640 can be implemented to map the encoded bits to a corresponding symbol (e.g., modulation symbol) of the constellation corresponding to the modulation or modulation scheme (e.g., modulation coding scheme (MCS)) implemented by the PAS encoder 620 and PAS transmitter system 600 of FIG. 6. For example, when the PAS encoder 6209 and PAS transmitter system 600 implement a QAM modulation, the symbol mapper 640 can be implemented as a QAM mapping component that uses the (m−1)n shaped systematic bits from the output 635 of the FEC encoder 630 as input for mapping to the QAM's amplitude (e.g., the input to the symbol mapper 640 comprising the output 635 comprising the (m−1)n shaped systematic bits can be mapped to shaped Tx amplitude information 642 (e.g., a) for the output modulation symbol 650 (e.g., x=a·s) determined by the symbol mapper 640). The output modulation symbol 650 can also be referred to as an output modulation symbol mapping. The output modulation symbol 650 (e.g., x=a·s) determined by the symbol mapper 640 can be an output modulation symbol of the PAS transmitter system 600 (e.g., can be a modulation symbol for transmission from the PAS transmitter system 600 to a corresponding PAS-reception scheme that includes a PAS decoder and FEC decoder corresponding to the respective PAS encoder 620 and FEC encoder 630 of FIG. 6, etc.).

The FEC encoder 630 can be additionally fed with a tunable (e.g., configurable, based on the value of the configurable or tunable parameter μ) quantity of non-shaped systematic bits 634, which can be the same as the non-shaped bits un split from the input sequence c 604 by the splitter 606. In some aspects, by setting the parameter μ=0, the FEC encoder 630 is fed with zero non-shaped systematic bits (e.g., the FEC encoder 630 does not receive an input of non-shaped systematic bits in examples where the parameter μ=0). For values of the configurable parameter μ>0, the FEC encoder 630 is fed with the input 610 comprising the quantity of one or more non-shaped systematic bits 634 μn.

The non-shaped systematic bits μn 634 are non-shaped, and are uniformly distributed with a ½ probability of value ‘0’ and a ½ probability of value ‘1’. In some aspects, the non-shaped systematic bits μn 634 can be configured for use by the FEC encoder 630 as sign bits for the symbol mapping performed by symbol mapper 640 to determine the modulation symbol 650.

The FEC encoder 630 can additionally be configured to generate and append one or more parity bits 636 (e.g., parity check bits or non-shaped parity check bits) to the encoded bit sequence comprising the shaped systematic bits 632 (e.g., (m−1)n) and the non-shaped systematic bits 634 (e.g., un). The FEC encoder 630 can generate and append the parity check bits 636 to also be non-shaped bits, such that the parity check bits 636 and the non-shaped systematic bits 634 each have their 0/1 probabilities equal to ½. In some aspects, the parity check bits 636 are also used as sign bits, based on having 0/1 probabilities of ½. For example, the symbol mapper 640 can use the (m−1)n shaped systematic bits 635 as the shaped Tx amplitude information a 642 for determining the output modulation symbol 650 (e.g., x=a·s), and can use a set of n non-shaped bits 638 as the non-shaped Tx sign-bit information s 644 for determining the output modulation symbol 650 (e.g., x=a·s). In an illustrative example, the set of non-shaped sign bits 638 includes the set un of non-shaped systematic bits 634 and the set of non-shaped parity check bits 636 given as (1−μ)n (e.g., where the number of non-shaped sign bits 638=μn+ (1−μ)n=n non-shaped sign bits 638).

As noted above, for a PAS transmission scheme that includes a PAS encoder (e.g., PAS encoder 620, etc.) with a distribution matcher (e.g., DM 622, etc.) and a FEC encoder (e.g., FEC encoder 630, an LDPC encoder, a polar encoder, a Reed-Soloman error correcting encoder, etc.), the use of the probabilistic amplitude shaping performed by the PAS encoder distribution matcher can correspond to the introduction of a PAS or DM overhead that may cause the FEC encoder to increase its code rate value to be closer to 1 (e.g., causing the FEC encoder to weaken its code rate) to compensate for the PAS or DM overhead. For example, the DM 622 of the PAS encoder 620 of FIG. 6 has, in the example of Table 1, an average input length that is shorter than the output length. For example, the average input length in the example of Table 1 for the DM 622 distribution shaping is 2.75 bits, and the output length is 3 bits. The DM overhead associated with this example can be represented or given by the DM rate R_{DM}, where R_{DM}=average input size/average output size=2.75/3=0.917. The DM overhead is then 1−R_{DM}=1−0.917=0.083.

For a PAS transmission scheme using a PAS encoder and/or a distribution matcher implementing probabilistic amplitude shaping, in combination with a FEC encoder that receives shaped bits from the PAS encoder or distribution matcher, the FEC encoder may be required to operate at a code rate that is greater than a particular threshold rate. The threshold rate of a FEC encoder operating in a PAS transmission scheme can depend on the modulation order of the modulation implemented by the PAS transmission scheme (e.g., the modulation order of the modulation scheme, MCS, etc.), where the higher the modulation order, the higher the minimum threshold code rate becomes for the FEC encoder (e.g., for higher modulation order, the FEC encoder may be required to implement higher and higher code rates, with fewer and fewer parity bits remaining in the encoded and punctured output bit sequence from the FEC encoder). The increase in the minimum threshold FEC encoder code rate for higher modulation orders in PAS transmission schemes can correspond to a wide range of low to medium code rates being invalidated for use in the PAS transmission scheme, based on the low to medium code rates being below the minimum threshold code rate that is required for the FEC encoder based on the PAS modulation order.

For example, a code rate of the FEC encoder 630 can correspond to the number of non-shaped systematic bits (e.g., non-shaped systematic bits 634 μn) and the number of parity check bits (e.g., non-shaped parity check bits 636 (1−μ)n) that the FEC encoder 630 includes in its encoded output along with the shaped systematic bits 632 (m−1)n. For example, the code rate of the FEC encoder 630 can be determined as the number of information-bearing (e.g., systematic bits) divided by the total bits output by the FEC encoder 630, as the FEC encoder rate R_{FEC}, where:

$${R}_{FEC} = \frac{( m - 1 ) n + μ n}{( m - 1 ) n + μ n + ( I - μ ) n} = \frac{m - 1 + μ}{m} \qquad Eq . ( 1 )$$

In the example PAS transmitter system 600 of FIG. 6, the FEC encoder 630 can be configured according to a FEC encoder rate configuration 660. For example, the FEC encoder rate configuration 660 can be a coding configuration that implements one mother code rate for the FEC encoder 630, where the mother code rate may be less than, equal to, or greater than the rate R_{FEC} of Eq. (1). In some examples, the FEC encoder 630 can be bounded by a minimum threshold code rate for the FEC encoder 630 when used with PAS, where the minimum threshold code rate is equal to the R_{FEC} of Eq. (1), above. In some aspects, the threshold FEC encoder rate R_{FEC} is the minimum threshold code rate for the FEC encoder in a PAS transmission scheme including a PAS encoder and/or distribution matcher along with the FEC encoder.

The threshold FEC encoder rate for PAS transmission schemes (e.g., R_{FEC} of Eq. (1)) is a minimum code rate threshold, or lower bound, that is a factor with dependence on the modulation order of the modulation or MCS implemented by the PAS transmission scheme (e.g., implemented by the PAS encoder, distribution matcher, etc., of the PAS transmission scheme that includes the FEC encoder). For example, the factor m in the threshold FEC code rate R_{FEC} can be related to the modulation order of the PAS transmission scheme as a QAM order (e.g., for QAM modulation, modulation order=2^{m}). Other relationships between m and the modulation scheme modulation order may also be utilized to obtain the value of m according to the modulation order configured for the PAS transmission scheme.

As noted above, for higher order modulations used for the PAS amplitude shaping, the threshold code rate R_{FEC} that the FEC encoder 630 is required to implement also increases with m. In some examples, for PAS-mode transmissions and/or PAS transmission schemes (e.g., such as PAS transmitter system 600), higher order modulations may force the FEC encoder 630 to be heavily punctured for the higher code rates R_{FEC} that are away from the native code rate of the FEC encoder 630 (e.g., the mother code rate, or inherent code rate of the FEC encoder 630 with no puncturing or rate adaptation applied on the encoded output of the FEC encoder 630).

For example, in at least some cases, the 5G NR specification utilizes FEC encoder configuration(s) with the NR mother code rate of ⅓ (e.g., a NR mother code rate corresponding to a native code rate configuration causing the FEC encoder to transmit 1 systematic/information bit for every 3 total bits encoded; e.g., 1 systematic bit to every 2 parity bits, etc.).

Some higher order modulations that may be implemented for a PAS transmission scheme can correspond to the threshold FEC encoder rate R_{FEC} being forced to code rates that are much higher than the native ⅓ code rate specified as the NR mother code for the FEC encoder more generally. For example, when operating in 1 k-QAM, to achieve an example threshold R_{FEC}=0.8, or above, the NR mother code rate of ⅓ may be heavily punctured to achieve a punctured or effective code rate equal to the required R_{FEC} of 0.8 or above.

The FEC rate represented in Eq. (1), e.g.,

$${R}_{FEC} = \frac{m - 1 + μ}{m} ,$$

can be a threshold FEC code rate that governs the FEC output based on the modulation order and/or DM overhead associated with probabilistic amplitude shaping that is performed upstream of (e.g., prior to, before, etc.) the FEC encoder receives input bits for encoding. According to R_{FEC} of Eq. (1), the FEC rate is governed in a PAS transmission scheme so that the FEC output includes (m−1) bits for every one sign bit, for a total FEC output of m bits per I/Q signed value (e.g., per I/Q signed value, the FEC output includes the (m−1) amplitude bits+1 sign bit=m total bits per I/Q signed value).

The modulation order for the modulation or modulation scheme (e.g., MCS, etc.) implemented by the transmitter or coding system that includes the FEC encoder (e.g., PAS transmission scheme, etc.) is represented as modulation order=2·m, which can also be expressed as

$$m = \frac{modulation order}{2} ,$$

meaning that the term m can be calculated as a value equal to half the value of the modulation order for the PAS transmission scheme.

For example, for 1024-QAM modulation, there are 2·m=10 bits per symbol, or per I/Q there are m=5 bits, with the m=5 bits comprising 4 bits for amplitude+1 sign bit.

In the example of the distribution matcher (DM) 622 of FIG. 6, and the distribution for the DM 622 illustrated in the example of Table 1, the overhead corresponding to a longer output length (e.g., output length=3 bits) from the DM 622 than the average input length to the DM 622 (e.g., average input length=2.75 bits) can be referred to as the DM overhead, or PAS overhead. For example, the DM 622 of the PAS encoder 620 of FIG. 6 has, in the example of Table 1, an average input length that is shorter than the output length. For example, the average input length in the example of Table 1 for the DM 622 distribution shaping is 2.75 bits, and the output length is 3 bits. The DM overhead associated with this example can be represented or given by the DM rate R_{DM}, where R_{DM}=average input size/average output size=2.75/3=0.917. The DM overhead is then 1−R_{DM}=1−0.917=0.083.

For the example PAS transmitter system 600, the FEC encoder 630 may additionally correspond to an additional FEC overhead, corresponding to the FEC code rate (e.g., R_{FEC}, or the difference between the average input size and average output size of the FEC encoder 630). In the PAS transmitter system 600 including the PAS encoder 620 with DM 622, and including the FEC encoder 630, the total overhead for the PAS transmitter system 600 can be based on the combination or sum of the DM overhead and the FEC overhead.

In some cases, increases to the DM overhead can be compensated based on the PAS transmission scheme being configured to decrease the FEC overhead (e.g., based on total overhead=DM overhead+FEC overhead, the total overhead can be maintained as approximately constant by reducing the FEC overhead in response to an increase in the DM overhead). Decreasing the FEC overhead corresponds to increasing the FEC code rate (e.g., R_{FEC}) to a value closer to 1, based on the FEC overhead being equal to 1−R_{FEC} (e.g., a FEC encoder with rate R_{FEC}=1 has zero FEC overhead). Increasing the FEC code rate R_{FEC} is also referred to as weakening the code rate for the FEC encoder, based on the higher value of the FEC code rate R_{FEC} corresponding to fewer error correction or parity check bits 636 in the encoded output from the FEC encoder 630.

Decreasing the FEC overhead by increasing the value of the FEC code rate R_{FEC} can, in some examples, be implemented by controlling the parameter u to increase or decrease the number of parity check bits 636 that are generated and appended by the FEC encoder 630. For example, the total number of sign bits 644 output by the FEC encoder 630 can be equal to n, where n is the number of the combined non-shaped bits 638 (i.e., the total number of sign bits 644 can be equal to the un non-shaped systematic bits 634 and the (1−μ)n parity check bits 636). Adjusting the value of the configurable parameter μ can be used tom adjust the balance between DM overhead (e.g., corresponding to DM 622 of PAS transmitter system 600) and FEC overhead (e.g., corresponding to FEC encoder 630 of PAS transmitter system 600).

In some cases, before using the parameter μ to implement or control overhead balancing between the DM overhead and the FEC overhead, the use of a PAS transmission scheme that includes a distribution matcher 622 for PAS amplitude shaping and a FEC encoder 630 for error correction and/or parity bit generation can be associated with a threshold that limits the strongest code rate (e.g., corresponding to μ=0) for the FEC encoder from below by:

$${R}_{FEC} {\vert}_{μ = 0} \geq \frac{m - 1}{m} \qquad Eq . ( 2 )$$

The minimum lower threshold on the FEC encoder 630 code rate R_{FEC}, as given in Eq. (2) above, can be obtained based on evaluating Eq. (1) using a value of μ=0 for the configurable overhead balancing parameter μ.

The threshold limit on the strongest code rate (e.g., lowest code rate value for the FEC encoder 630 and compatible with a PAS transmission scheme, etc.) for the FEC encoder, R_{FEC}|_{μ=0}, can require very high FEC code rates for the FEC encoder 630 when used in PAS transmission schemes with high order modulations with an order of modulation=2·m. High values of the minimum FEC code rate can require heavy puncturing to be implemented by the FEC encoder 630 to puncture (e.g., remove) parity bits from the encoded FEC output (e.g., n non-shaped bits 638) and/or can require heavy puncturing to otherwise be applied to the FEC output of the non-shaped bits 638, prior to their input to the symbol mapper 640 as the non-shaped Tx sign bit information s for determining the modulation symbol 650 for output as the modulation symbol 650 x=a·s.

For example, for higher order modulations and modulation schemes with an order of modulation=2·m, the minimum threshold FEC code rate of Eq. (2) (e.g., R_{FEC}|_{μ=0}, which is the minimum, or strongest code rate that can be used by the FEC encoder 630 given the modulation order 2·m) may force the FEC encoder 630 to relatively high code rates in order to decrease the FEC overhead in compensation for an increase in the DM overhead of the DM 622, given a constraint or configuration of a fixed total overhead for the PAS transmission scheme including the DM 622 and the FEC encoder 630.

High code rates of the FEC encoder 630 can correspond to heavy puncturing being performed by and/or after the FEC encoder 630 to achieve the requisite high code rate. Heavy puncturing by the FEC encoder 630 can correspond to significant performance degradation relative to an example of a FEC encoder that achieves the same higher code rate as its native (e.g., mother) code rate. For example, a FEC encoder with the NR mother code rate=1/3 performs heavier puncturing to reach a threshold PAS-mode FEC code rate limit of R_{FEC}|ᵤ₌₀=0.80, as compared to an example FEC encoder that has a native or mother code rate=0.75. For example, the FEC encoder with the NR mother code rate of ⅓ performs heavy puncturing from ⅓=0.33 to 0.80, while the example FEC encoder with a different native (e.g., mother) code rate of 0.75 performs only light puncturing from 0.75 to 0.8. Heavy puncturing by the FEC encoder 630 can cause the FEC encoder 630 to operate beyond its maximum puncturing threshold, which causes the code to completely collapse (e.g., for NR LDPC, the maximum puncturing threshold before code collapse may be given as the set of code rates r≥0.930).

In some aspects, in a PAS transmission scheme using a distribution matcher or other probabilistic amplitude shaping associated with a modulation order given as modulation order=2·m, the minimum threshold (e.g., lower limit for the strongest FEC code rate) of the FEC code rate R_{FEC} of Eq. (1) and/or Eq. (2) causes the FEC encoder 630 to be bounded from below by the threshold R_{FEC, lower bound}, where:

$${R}_{FEC , lower bound} = \frac{m - 1}{m} \qquad Eq . ( 3 )$$

For example, Table 2, below, depicts examples of PAS mode R_{FEC}, lower bound values that bound from below the code rate that can be implemented by the FEC encoder in the PAS mode transmission scheme.

TABLE 2
Example PAS mode implementations where a FEC encoder
code rate R_{FEC} is bounded from below by a
minimum threshold code rate R_{FEC},_{lower bound} based
on the modulation and/or modulation order of the
PAS mode transmission scheme. In PAS mode, the
FEC code rate is forced to be above a base,
threshold rate corresponding to μ = 0, given by
${R}_{FEC , lower bound} = \frac{m - 1}{m} .$

| | Modulation | |
|---|---|---|
| | Order | R_{FEC, lower bound} |
| Modulation | 2 · m | m − 1/m |
| 256-QAM | 8 (m = 4) | 3/4 = 0.750 |
| 1k-QAM | 10 (m = 5) | 4/5 = 0.800 |
| 4k-QAM | 12 (m = 6) | 5/6 = 0.833 |
| 16k-QAM | 14 (m = 7) | 6/7 = 0.858 |

In a PAS transmission scheme, the lower bound corresponding to the FEC code rate threshold

$${R}_{FEC , lower bound} = \frac{m - 1}{m}$$

of Eq. (3) can push the FEC code rate to high enough code rate values that the FEC encoder is forced to operate beyond a maximum puncturing threshold, which causes the FEC code (e.g., NR LDPC, polar, Reed-Solomon, etc.) to collapse. For example, in a PAS transmission scheme with 1 k-QAM modulation, the modulation order is equal to 10, and m=10/2=5. As shown in the example of Table 2, a 1 k-QAM modulation in a PAS mode transmission scheme corresponds to the FEC encoder 630 being unable to operate a code rate below 0.800, based on the value of R_{FEC, lower bound} being equal to (5−1)/5=4/5=0.800.

For the relatively high minimum (e.g., threshold) code rates for the FEC encoder 630 (e.g., shown in Table 2 as R_{FEC, lower bound} for the higher order modulations with modulation order=2·m), configuring the FEC encoder 630 to use the NR LDPC mother code rate of ⅓ (e.g., in examples where the FEC encoder 630 is an NR LDPC encoder, etc.) can be inefficient for PAS modulations, based on the heavy puncturing required to take the FEC encoder 630 from its mother (e.g., native) code rate of ⅓ up to the required minimum threshold R_{FEC, lower bound} of 0.800. Additionally, a FEC encoder 630 implementing a native code rate equal to the NR LDPC mother code rate of ⅓ would be required to always go through heavy puncturing, all the way from ⅓ up to at least 0.800 and beyond. Heavy puncturing of the FEC encoder 630 native code rate to reach the higher, minimum threshold rate R_{FEC, lower bound} required for the FEC encoder 630 in PAS transmission schemes can incur high degradation for the PAS transmission scheme coding system.

In one illustrative example, the systems and techniques described herein can be used to implement a FEC encoder for a PAS transmission scheme, where the FEC encoder is configured with multiple codes having different respective native (e.g., mother) code rates. Based on selecting a particular code having a respective native code rate that is closer to the value of the required threshold code rate R_{FEC, lower bound} for the PAS transmission scheme, the systems and techniques can reduce the puncturing performed for the FEC encoder. In one illustrative example, the systems and techniques can be used to provide a PAS transmission scheme with a FEC encoder that may be configured with a different FEC mother code rate (e.g., a different FEC native code rate) per modulation scheme and/or modulation order of the PAS encoder included in the PAS transmission scheme.

For example, the FEC encoder 630 of FIG. 6 can be configured with a new FEC mother code rate R_{FEC} on a per-modulation basis when the FEC encoder 630 is used in PAS mode (e.g., when the FEC encoder 630 is used in a PAS transmission scheme such as the PAS transmitter system 600, and/or when the FEC encoder 630 is used with a distribution matcher such as DM 622, etc.). In an illustrative example, a FEC encoder can be implemented as a FEC encoder configured with a plurality of different mother code rates, where the plurality of different mother code rates correspond to different modulations and/or modulation orders, based on the plurality of different mother code rates following the form given in Eq. (3), where

$${R}_{FEC} = \frac{m - 1}{m} .$$

For example, a FEC encoder can be configured with a set of multiple different mother code rates of

$$\{ 3 / 4 , 4 / 5 , 5 / 6 , 6 / 7 , … , \frac{m - 1}{m} \}$$

for a configured range of different modulations. For example, a FEC encoder configured with the set of multiple mother code rates

$$\{ 3 / 4 , 4 / 5 , 5 / 6 , 6 / 7 , … , \frac{m - 1}{m} \}$$

can be used to support modulations of 256-QAM, 1 k-QAM, 4 k-QAM, 16 k-QAM, . . . , 2²^{^{m}} QAM, in examples where the FEC encoder with the multiple mother code rates is used in PAS mode and/or is used in a PAS transmission scheme, as noted above.

The FEC encoder configured with the set(s) of multiple different mother code rates can be implemented by various different types of FEC encoders. For example, the FEC encoder 630 and/or other FEC encoder with multiple mother code rates can be an LDPC FEC encoder, a polar FEC encoder, etc. The set of mother code rates (e.g., native rates without puncturing) can be configured for the various types of FEC encoders according to the relationship given in Eq. (3) for the minimum threshold FEC code rate in PAS mode,

$${R}_{FEC , lower bound} = \frac{m - 1}{m} .$$

In some aspects, the multiple mother code rates that can be implemented for the FEC may each correspond to a different, respective configuration of the FEC encoder or FEC decoder. For example, a respective configuration for the FEC encoder or decoder can be implemented according to a corresponding parity check matrix H^{T} and/or a corresponding inverse parity check matrix (H⁻¹)^{T}. The respective native (e.g., mother) code rate configured for the FEC encoder or FEC decoder can be based on the dimensions of the respective parity check matrix H^{T} or inverse parity check matrix (H⁻¹)^{T} of the configuration. In one illustrative example, the systems and techniques can provide a FEC coding configuration that can be used to reduce puncturing in a PAS coding system or PAS coding scheme, based on the FEC coding configuration including multiple codes with different native rates of the form

$$\frac{m - 1}{m} ,$$

where the term m represents a value corresponding to the modulation order and/or modulation scheme implemented by the PAS coding scheme. For example, the term m can be related to the modulation order of the PAS coding scheme as modulation order=2^{m}, where m=log₂ (modulation order). In some aspects, the FEC encoder or decoder can implement multiple different codes with native rates of the form

$$\frac{m - 1}{m} ,$$

where m is the binary logarithm (e.g., log₂) of the modulation order associated with the respective PAS encoder or decoder corresponding to the FEC encoder or decoder in the PAS coding system or PAS coding scheme.

In one illustrative example, the systems and techniques can reduce puncturing and increasing efficiency of the FEC encoder of a PAS mode transmission system and/or a PAS transmission scheme based on using the multiple mother code rates configured for the FEC for use with different modulations and modulation orders, as the FEC encoder can start from a mother code rate that is closer in value to the threshold minimum required FEC rate R_{FEC, lower bound} given in Eq. (3) for the current modulation and modulation order. Starting the FEC encoder with a coding configuration that has a mother rate closer to the minimum threshold R_{FEC, lower bound} can leave more overhead or room for the FEC encoder to subsequently perform compensation for any DM overhead by increasing the FEC code rate beyond the minimum threshold R_{FEC, lower bound} to cause a decreased in the FEC overhead that is equal to or corresponds to the increase in DM overhead being compensated.

For example, a PAS mode communication link may be configured to operate with a typical or target desired code rate of 0.858. DM overhead associated with the DM 622 may be equal to a 5% overhead, corresponding to a DM rate of 0.950 for the DM 622. In one illustrative example, to maintain the total overhead rate intact at the target desired code rate of 0.858, the FEC code rate R_{FEC} is weakened in order to increase R_{FEC} by an amount corresponding to a decrease in FEC overhead that matches or compensated the DM overhead.

For example, the target FEC code rate of 0.858 may be rate adjusted (e.g., using puncturing and/or various other rate adaptation techniques, etc.) from the desired rate of 0.858 to an adapted FEC code rate equal to

$$\frac{0.858}{0.95} = 0.913 .$$

For example, the adaptation of the FEC code rate for compensating the DM overhead can be determined based on the relationship

$${R}_{FEC , adapted} = \frac{{R}_{FEC , target}}{{R}_{DM}} ,$$

where R_{FEC, adapted} is the adapted FEC code rate for a decreased FEC overhead to compensate the DM overhead equal to 1−R_{DM}, and where R_{FEC, target} is the desired or target FEC code rate that may, for example, correspond to the typical desired code rate for operating the link associated with the FEC and the PAS mode transmission scheme.

In the example above, the adapted FEC code rate of 0.913 may be configured as the code rate needed from the FEC encoder 630. For a FEC encoder 630 that implements an NR LDPC encoder with the NR mother code rate of ⅓, implementing an adapted rate of 0.913 can correspond to heavy puncturing with poor performance based on the high degradation caused by the heavy puncturing of the code from the NR mother code rate of ⅓ up to the adapted FEC code rate of 0.913 needed for PAS mode and DM overhead compensation.

Using the systems and techniques to provide the FEC encoder 630 with multiple configurations with different respective mother code rates associated with each configuration for the FEC encoder 630, the DM overhead compensation can be performed by using light puncturing to go from a native (e.g., mother) code rate that is selected and implemented for the FEC encoder 630 to be closer to the target FEC code rate value of 0.913. For example, the FEC encoder 630 can be configured with a code having a native (e.g., mother) code rate obtained according to the examples of Table 2. In one illustrative example, the FEC encoder 630 can be configured with a native (e.g., mother) code rate of 0.858 for 16 k-QAM modulation, as illustrated above in Table 2. Configuring the FEC encoder with a native (e.g., mother) code rate of 0.858 can reduce the puncturing performed to implement the adapted FEC code rate value of 0.913 for DM overhead compensation. For example, the use of the multiple mother code rates for the FEC encoder can correspond to performing light puncturing from the 0.858 16 k-QAM mother code rate to the R_{FEC} target of 0.913 (e.g., 0.913−0.858=0.055), which is a lighter puncturing than the heavy puncturing needed for the NR LDPC mother code rate of ⅓ to reach the same R_{FEC} target of 0.913 (e.g., 0.913−0.333=0.580).

In some aspects, configuring the FEC encoder to select a configuration from the set of multiple configurations with multiple different native (e.g., mother) code rates can cause the FEC encoder 630 to operate much closer to its native mother code rate, even after adaptation or compensation for DM overhead, minimum threshold R_{FEC, lower bound} requirements, etc., are applied. Operating the FEC encoder 630 closer to the mother code rate corresponds to operating the FEC encoder 630 with light or no puncturing performed on the encoded bits output by the FEC encoder 630. Light or no puncturing provides better performance than an example FEC code that has a stronger (e.g., lower value) native mother code rate, but is subsequently required to go through a large puncturing distance corresponding to heavy puncturing from the lower mother code to the high R_{FEC} threshold or adapted rate required for the PAS mode transmission scheme with, or without, DM overhead compensation by the FEC encoder.

In another illustrative example, the PAS transmission scheme link may be configured to operate with a target or typical desired code rate of 0.983. With a DM overhead of 5%, corresponding to a DM rate of R_{DM}=0.950 for the DM 622, and in order to maintain the fixed total overhead rate intact at the target of 0.893, the FEC code rate will be compromised (e.g., weakened) by performing rate adaptation from the desired code rate of 0.893 as the FEC rate, to an adapted FEC rate of 0.893/0.950=0.940.

An adapted and/or punctured FEC code rate of 0.940 is incompatible with the NR LDPC FEC encoder, which uses the NR LDPC mother code rate of ⅓. Performing heavy puncturing or other rate adaptation to increase the FEC code rate from the NR LDPC mother rate of ⅓, up to the required puncturing or rate adaptation target of 0.940, will cause the code to collapse. For example, unable to perform bit error rate (BER) correction, the NR LDPC code can collapse beyond rates of 0.930 (e.g., for rates higher than 0.930). In examples of PAS mode transmission schemes where the FEC encoder uses a configuration with a single native (e.g., mother) code rate, the FEC encoder and associated PAS mode transmission scheme may be unable to operate the link at the desired rate of 0.893, which can be a common rate and/or within a common rate range for many MSCs and/or modulations that are used for PAS mode transmission schemes. In an illustrative example, the systems and techniques can be used to configure the FEC encoder with a selected mother code rate such as the 0.858 mother code rate for 16 k-QAM in Table 2, which can be punctured over a relatively short distance from 0.858 up to 0.940 (e.g., 0.940−0.858=0.082, corresponding to light puncturing, etc.).

Using the selected mother code rate from the multiple configured mother code rates per-modulation for the FEC encoder 630 can be used for the FEC encoder to successfully and efficiently operate the link at the total overhead equal to the desired target overhead of rate=0.893. In some examples, DM overhead for the DM 622 or other PAS mode DM can be higher than 5% overhead (e.g., the DM 622 rate R_{DM} can, in at least some examples, be closer to a code rate of R_{DM}=0.90, corresponding to a DM overhead of 10%). Higher DM overheads can correspond to larger FEC rate adaptation changes to reduce the FEC overhead by an amount equal to the DM overhead or DM overhead change that is being compensated by the FEC. The use of multiple configurations with respective multiple native code rates per-modulation to configure the FEC encoder of a PAS mode transmission scheme can reduce the puncturing needed for the FEC rate adaptation and/or FEC overhead reduction for compensating the DM overhead, and may correspond to improved performance over heavier puncturing techniques using lower native (e.g., mother) code rates for the FEC encoder.

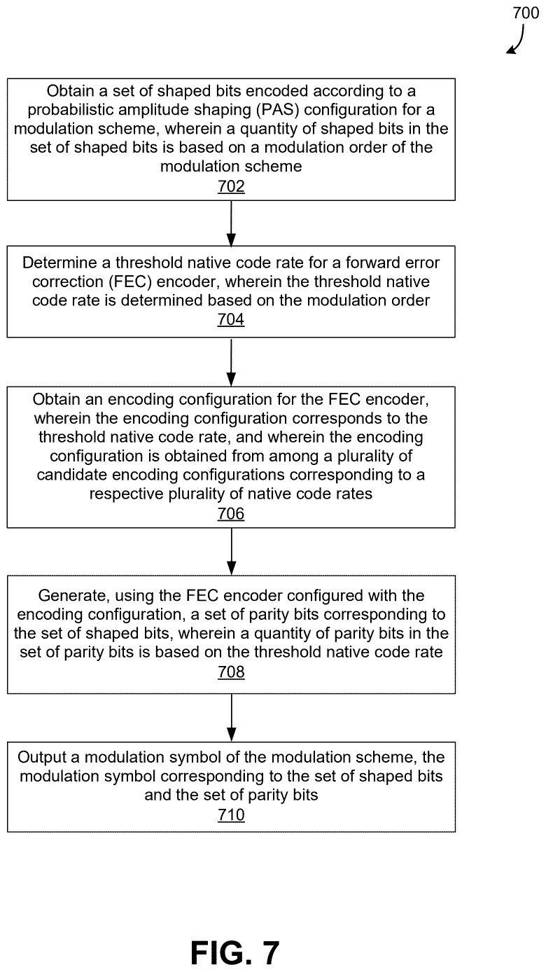

FIG. 7 is a flowchart diagram illustrating an example of a process 700 for wireless communication. The process 700 may be performed by a network entity or network device (or apparatus) or a component (e.g., a chipset, codec, etc.) of the network entity or device. The network entity may be a UE (e.g., the UE 104 of FIG. 1, FIG. 2, and/or FIG. 3, the wireless device 407 of FIG. 4, or other UE). The network entity (e.g., UE) can be a mobile device (e.g., a mobile phone), a network-connected wearable such as a watch, an extended reality (XR) device (e.g., a virtual reality (VR) device or augmented reality (AR) device), a vehicle or component or system of a vehicle, or other type of computing device configured to perform wireless communications. The operations of the process 700 may be implemented as software components that are executed and run on one or more processors (e.g., the transmit processor 264, the receive processor 258, the TX MIMO processor 266, the MIMO detector 256 of FIG. 2, the processing system 470 of FIG. 4, the processor(s) 484 of FIG. 4, the processing system 902 of FIG. 9, and/or the processor 910 of FIG. 9, or other processor(s) (e.g., such as one or more other processors included within and/or associated with the processing system 470 of FIG. 4, the processing system 902 of FIG. 9, etc.). Further, the transmission and reception of signals by the network entity in the process 700 may be enabled, for example, by one or more antennas, one or more transceivers (e.g., wireless transceiver(s)), and/or other communication components (e.g., the transmit processor 264, the receive processor 258, the TX MIMO processor 266, the MIMO detector 256, the modulator(s)/demodulator(s) 254a through 254t, and/or the antenna(es) 252a through 252t of FIG. 2, the antenna(es) 487 of FIG. 4, the wireless transceiver(s) 478 of FIG. 4, the communication interface 940 of FIG. 9, or other antennae(s), transceiver(s), and/or component(s)).

For example, the process 700 can be performed by a PAS-based transmitter and/or a PAS-based transmission system (e.g., such as the PAS transmitter system 600 of FIG. 6, etc.). In some cases, the process 700 can be performed by a transmission system configured to apply PAS or PAS-based modulation and FEC encoding to generate an amplitude-shaped output signal including FEC information for transmission.

At block 702, the network entity (or component thereof) can obtain a set of shaped bits encoded according to a probabilistic amplitude shaping (PAS) configuration for a modulation scheme, wherein a quantity of shaped bits in the set of shaped bits is based on a modulation order of the modulation scheme. In some cases, the PAS configuration can be the same as or similar to the example of the non-uniform distribution 500 of constellation point probabilities corresponding to a distribution matcher for amplitude shaping of FIG. 5, in accordance with some examples. In some examples, the set of shaped bits can be associated with an input bit sequence or plurality of bits, for example the input bits c 604 of FIG. 6, etc. In some examples, the set of shaped bits can be obtained from an output of a PAS encoder, such as a PAS encoder corresponding to the PAs encoder 620 of FIG. 6, etc.

In some cases, the set of shaped bits can be the (m−1)n shaped bits 628 generated as output by the amplitude-to-bits mapper 626 of the PAS encoder 620. In some examples, the set of shaped bits can be the shaped systematic bits 632 associated with the FEC encoder 630 of FIG. 6, and/or the (m−1)n shaped systematic bits output 635 from the FEC encoder 630 of FIG. 6, etc.

In some examples, the modulation order can be determined based on a modulation coding scheme (MCS) implemented by a probabilistic amplitude shaping encoder using the PAS configuration. For example, the modulation order may be based on an MCS implemented by the PAS encoder 620 of FIG. 6, etc. In some cases, the quantity of shaped bits in the set of shaped bits can be based on the modulation order of the modulation scheme according to (m−1)n, where the modulation order is equal to 2·m.

In some cases, to obtain the set of shaped bits, the network entity (or component thereof) can be configured to obtain the set of shaped bits from a distribution matcher configured with the PAS configuration. For example, the set of shaped bits can be obtained from a distribution matcher the same as or similar to the distribution matcher 622 of FIG. 6, etc. The set of shaped bits can be a set of shaped systematic bits, such as the shaped systematic bits 632 of FIG. 6. In some cases, the distribution matcher is included in a probabilistic amplitude shaping encoder associated with a FEC encoder. For example, the distribution matcher can correspond to the distribution matcher 622 of FIG. 6, which can be included in the PAS encoder 620 associated with the FEC encoder 630 of FIG. 6, etc.

At block 704, the network entity (or component thereof) can determine a threshold native code rate for a forward error correction (FEC) encoder, wherein the threshold native code rate is determined based on the modulation order. For example, the FEC encoder can be the same as or similar to the FEC encoder 630 of FIG. 6, etc. In some cases, the FEC encoder can implement various types of forward error correction, and may be configured as an LDPC encoder, a polar encoder, a Reed-Solomon encoder, etc., among various others. In some examples, the FEC encoder can be associated with a distribution matcher (DM) implementing the PAS configuration to generate the set of shaped bits from an input set of bits. For example, the FEC encoder can be associated with the DM 622 of FIG. 6, etc. In some cases, the FEC encoder can be a low-density parity check (LDPC) encoder or a polar encoder.

In some examples, to determine the threshold native code rate for the FEC encoder, the network entity (or component thereof) can be configured to determine a value equal to one half multiplied by the modulation order, and to divide a numerator equal to the value minus one by a denominator equal to the value. For example, the value equal to one half multiplied by the modulation order may be the same as m (e.g., based on the expression modulation order=2·m being re-written as m=½·modulation order). The numerator equal to the value minus one can be the same as m−1. The denominator equal to the value can be the same as m. To determine the threshold native code rate for the FEC encoder, using the value (e.g. m), the network entity (or component thereof) can be configured to divide m−1 by m, for example to determine

$$\frac{m - 1}{m}$$

as the threshold native code rate for the FEC encoder.

In some examples, the threshold native code rate for the FEC encoder is greater than or equal to one half the modulation order minus one, divided by one half the modulation order. For example, one half the modulation order can be the same as m, as noted above, and the threshold native code rate for the FEC encoder may be greater than or equal to m−1, divided by m

$$( e . g . , greater than or equal to \frac{m - 1}{m} ) .$$

In some cases, the threshold native code rate can be indicative of a minimum code rate configured for the FEC encoder corresponding to the PAS configuration. In some examples, the threshold native code rate can be a mother code rate for the FEC encoder without puncturing. In some cases, the threshold native code rate for the FEC encoder is determined based on a square root. For example, in some cases the threshold native code rate for the FEC encoder may be based on a square root of the modulation order of the modulation scheme, and/or a square root corresponding to a value or parameter within the PAS configuration, the encoding configuration, etc. In some cases, the threshold native code rate for the FEC encoder and an encoding configuration for the FEC encoder can be determined based on the modulation scheme of the probabilistic amplitude shaping encoder. For example, the modulation scheme of the PAS encoder 620 of FIG. 6 can be used to determine the threshold native code rate for FEC encoder 630 of FIG. 6, and can additionally be used to determine a corresponding encoding configuration for the FEC encoder 630 of FIG. 6.

In some examples, a shaping gain associated with the probabilistic amplitude shaping encoder and the set of shaped bits can correspond to a target rate matching value for the FEC encoder. For example, a target rate matching value for the FEC encoder 630 can correspond to a shaping gain associated with the PAS encoder 620 of FIG. 6. The shaping gain can be indicative of a ratio between the number of shaped bits and the number of non-shaped bits output from the PAS encoder 620. In some cases, the shaping gain can be represented as a ratio between the number of shaped bits generated for a total number of output bits of the PAS encoder 620. In some examples, the shaping gain can be a ratio between the number of shaped bits generated as output by the PAS encoder 620, for a number of coded bits k 608 of FIG. 6 input to the PAS encoder 620, etc.

At block 706, the network entity (or component thereof) can obtain an encoding configuration for the FEC encoder, wherein the encoding configuration corresponds to the threshold native code rate, and wherein the encoding configuration is obtained from among a plurality of candidate encoding configurations corresponding to a respective plurality of native code rates. For example, the encoding configuration for the FEC encoder can correspond to the example of the FEC encoder rate configuration 660 of FIG. 6, which can be implemented as an encoding configuration for the FEC encoder 630 of FIG. 6. In some cases, the encoding configuration for the FEC encoder (e.g., such as the FEC encoder rate configuration 660 of FIG. 6, etc.) can be a coding configuration that implements one mother code rate (e.g., a configuration with a single mother code rate to be used by the FEC encoder 630, etc.) for the FEC encoder 630, where the mother code rate may be less than, equal to, or greater than the rate R_{FEC} of Eq. (1), as noted above.

In some cases, the encoding configuration for the FEC encoder can be obtained from a plurality of different encoding configurations, where each respective encoding configuration of the plurality of different encoding configurations is associated with a different value of the threshold native code rate. For example, a first encoding configuration may be obtained to implement a first threshold native code rate for the FEC encoder. A second encoding configuration may be obtained to implement a second threshold native code rate for the FEC encoder, where the second threshold native code rate is different from the first threshold native code rate, etc. In some examples, the plurality of different encoding configurations with different threshold native code rates for the FEC encoder can be stored in a memory or storage associated with the network entity (or component thereof). In some examples, the encoding configuration can be indicative of a parity check matrix for the FEC encoder, the parity check matrix having dimensions corresponding to the threshold native code rate. For example, each respective encoding configuration of the plurality of encoding configurations can correspond to a different parity check matrix that can be used to configure the FEC encoder. Each different parity check matrix may implement a different threshold native code rate for the FEC encoder, where the different threshold native code rate implementation is based at least in part on the dimensions of each different parity check matrix in the different encoding configurations, etc.

In some examples, the encoding configuration can be a particular candidate encoding configuration included in the plurality of candidate encoding configurations. In some cases, a native code rate of the particular candidate encoding configuration is greater than or equal to the threshold native code rate determined based on the modulation order. For example, the network entity (or component thereof) can select or obtain the particular candidate encoding configuration from the plurality of candidate encoding configurations, based on the native code rate of the particular candidate encoding configuration being greater than or equal to the threshold native code rate that is determined based on the modulation order.

At block 708, the network entity (or component thereof) can generate, using the FEC encoder configured with the encoding configuration, a set of parity bits corresponding to the set of shaped bits, wherein a quantity of parity bits in the set of parity bits is based on the threshold native code rate.

For example, the FEC encoder 630 can be configured with the obtained encoding configuration to cause the FEC encoder 630 to implement the threshold native code rate corresponding to the obtained encoding configuration. The FEC encoder configured with the encoding configuration can generate a set of parity bits that may be the same as or similar to the parity check bits 636 of FIG. 6, for example which correspond to the set of shaped bits 632 of FIG. 6. In some cases, the quantity of parity bits in the set of parity bits can be based on the threshold native code rate, based on the quantity of parity bits being generated without puncturing by the FEC encoder (e.g., the FEC encoder implementing the threshold native code rate or higher, according to the encoding configuration, can correspond to the FEC encoder implementing a mother code rate that is high enough to perform forward error correction and generate the set of parity bits 636 without performing puncturing). In some examples, the quantity of parity bits divided by a sum of the quantity of shaped bits and the quantity of parity bits is greater than or equal to the threshold native code rate determined based on the modulation order. For example, the quantity of the parity check bits 636 of FIG. 6, divided by a sum of the quantity of shaped bits 632 of FIG. 6 and the quantity of parity check bits 636, may be greater than or equal to the threshold native code rate implemented for the FEC encoder 630 of FIG. 6 according to the obtained encoding configuration.

In some cases, to generate the set of parity bits, the network entity (or component thereof) can be configured to use a reduced rate matching value for the FEC encoder, wherein the reduced rate matching value is less than the target rate matching value. For example, the reduced rate matching value for the FEC encoder can be a reduced rate matching value for the FEC encoder 630 of FIG. 6. The reduced rate matching value for the FEC encoder can correspond to zero punctured parity bits by the FEC encoder when generating the set of parity bits. In some cases, the encoding configuration causes the FEC encoder to generate the set of parity bits without performing puncturing.

At block 710, the network entity (or component thereof) can output a modulation symbol of the modulation scheme, the modulation symbol corresponding to the set of shaped bits and the set of parity bits. For example, the modulation symbol can be determined and output using a symbol mapper that receives as input the set of shaped bits from the FEC encoder and the set of parity bits from the FEC encoder. In some cases, the symbol mapper can correspond to the symbol mapper 640 of FIG. 6, etc. The modulation symbol can be output based on the shaped Tx amplitude information 642 and the non-shaped Tx sign bit information 644 determined by the symbol mapper 640 of FIG. 6. For example, the modulation symbol output by the network entity (or component thereof) can correspond to the modulation symbol 650 output generated by the symbol mapper 640 of FIG. 6 (e.g., as x=a·s, etc.).

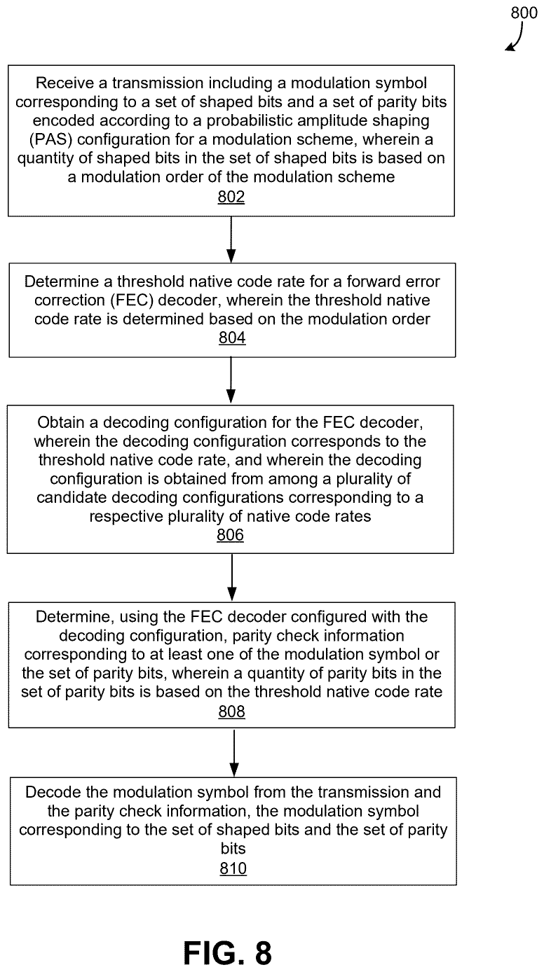

FIG. 8 is a flowchart diagram illustrating an example of a process 800 for wireless communication. The process 800 may be performed by a network entity or network device (or apparatus) or a component (e.g., a chipset, codec, etc.) of the network entity or device. The network entity may be a base station (e.g., an eNB, a gNB, etc.) or a portion of a base station (e.g., one or more of a CU, a DU, a RU, a Near-RT RIC, and/or a Non-RT RIC, such as the CU 310, the DU 330, the RU 340, the Near-RT RIC 325, and/or the Non-RT RIC 315 of the disaggregated base station 300 of FIG. 3), server device, or other network entity. The operations of the process 800 may be implemented as software components that are executed and run on one or more processors (e.g., the transmit processor 220, the receive processor 238, the TX MIMO processor 230, the MIMO detector 236 of FIG. 2, the processing system 470 of FIG. 4, the processor(s) 484 of FIG. 4, the processing system 902 of FIG. 9, and/or the processor 910 of FIG. 9, or other processor(s) (e.g., such as one or more other processors included within and/or associated with the processing system 470 of FIG. 4, the processing system 902 of FIG. 9, etc.). Further, the transmission and reception of signals by the network entity in the process 800 may be enabled, for example, by one or more antennas, one or more transceivers (e.g., wireless transceiver(s)), and/or other communication components (e.g., the transmit processor 220, the receive processor 238, the TX MIMO processor 230, the MIMO detector 236, the modulator(s)/demodulator(s) 232a through 232t, and/or the antenna(es) 234a through 234t of FIG. 2, the communication interface 940 of FIG. 9, or other antennae(s), transceiver(s), and/or component(s)).

For example, the process 800 can be performed by a PAS-based receiver and/or a PAS-based reception system (e.g., such as a PAS-based receiver and/or PAS-based reception system associated with the PAS transmitter system 600 of FIG. 6, etc.). In some cases, the process 800 can be performed by a receiver and/or reception system configured to apply PAS or PAS-based demodulation and FEC decoding to recover a bit sequence from a received amplitude-shaped signal including FEC information (e.g., the process 800 can be performed to recover the input bit sequence 604 from a received signal comprising output modulation symbol 650 of the PAS transmitter system 600 of FIG. 6, etc.).

At block 802, the network device (or component thereof) can receive a transmission including a modulation symbol corresponding to a set of shaped bits and a set of parity bits encoded according to a probabilistic amplitude shaping (PAS) configuration for a modulation scheme, wherein a quantity of shaped bits in the set of shaped bits is based on a modulation order of the modulation scheme.

In some examples, the received transmission including the modulation symbol can correspond to the output modulation symbol of block 710 of the process 700 of FIG. 7. For example, the process 700 can be performed by a first network entity (or component thereof) configured as an encoder and/or transmitter for a PAS coding scheme, and the process 800 can be performed by a second network entity (or component thereof) that is associated with the first network entity, and where the second network entity (or component thereof) is configured as a decoder and/or receiver for the PAS coding scheme, etc.

In some examples, the modulation order of block 802 can be determined based on a modulation coding scheme (MCS) implemented by a probabilistic amplitude shaping encoder using the PAS configuration. For example, the modulation order can correspond to an MCS and/or a respective modulation order implemented by a PAS encoder the same as or similar to the PAS encoder 620 of FIG. 6, etc.

In some cases, the modulation symbol of block 802 can correspond to the modulation symbol of block 710 of the process 700 of FIG. 7. In some examples, the set of shaped bits of block 802 can correspond to the set of shaped bits of block 702 of process 700 of FIG. 7. In some cases, the set of parity bits of block 802 can correspond to the set of parity bits of block 708 of process 700 of FIG. 7. In some examples, the PAS configuration for the modulation scheme of block 802 can correspond to the PAS configuration for the modulation scheme of block 702 of process 700 of FIG. 7. In some cases, the quantity of shaped bits in the set of shaped bits of block 802 can correspond to the quantity of shaped bits in the set of shaped bits of block 702 of process 700 of FIG. 7. In some cases, the modulation order of the modulation scheme of block 802 can correspond to the modulation order of the modulation scheme of block 702 of process 700 of FIG. 7.

At block 804, the network device (or component thereof) can determine a threshold native code rate for a forward error correction (FEC) decoder, wherein the threshold native code rate is determined based on the modulation order. For example, the threshold native code rate of block 804 can correspond to the threshold native code rate of block 704 of process 700 of FIG. 7. In some examples, the FEC decoder can correspond to and can be associated with the FEC encoder of block 704 of process 700 of FIG. 7, etc. In some examples, the threshold native code rate of block 804 and associated with the FEC decoder associated with process 800 can be the same as the threshold native code rate for the FEC encoder associated with process 700 of FIG. 7.

In some examples, to determine the threshold native code rate for the FEC decoder, the network entity (or component thereof) can be configured to determine a value equal to one half multiplied by the modulation order, and to then divide a numerator equal to the value minus one by a denominator equal to the value. In some cases, the threshold native code rate for the FEC decoder may correspond to a threshold rate

$$\frac{m - 1}{m} ,$$

etc. In some examples, the threshold native code rate for the FEC decoder can be greater than or equal to one half the modulation order minus one, divided by one half the modulation order. In some cases, the threshold native code rate is indicative of a minimum code rate configured for the FEC decoder and corresponding to the PAS configuration. In some examples, the threshold native code rate is a mother code rate for the FEC decoder without puncturing.

At block 806, the network device (or component thereof) can obtain a decoding configuration for the FEC decoder, wherein the decoding configuration corresponds to the threshold native code rate, and wherein the decoding configuration is obtained from among a plurality of candidate decoding configurations corresponding to a respective plurality of native code rates. For example, the decoding configuration can be indicative of a parity check matrix for the FEC decoder, the parity check matrix having dimensions corresponding to the threshold native code rate. In some cases, the threshold native code rate and the decoding configuration for the FEC decoder can be based on the modulation scheme.

At block 808, the network device (or component thereof) can determine, using the FEC decoder configured with the decoding configuration, parity check information corresponding to at least one of the modulation symbol or the set of parity bits, wherein a quantity of parity bits in the set of parity bits is based on the threshold native code rate. For example, the decoding configuration can cause the FEC decoder to determine the parity check information without puncturing. In some cases, the parity check information corresponds to the parity check bits 636 generated by the FEC encoder 630 of FIG. 6. In some cases, the parity check information corresponds to parity check bits generated by a corresponding FEC encoder associated with a FEC decoder configured to perform process 800 of FIG. 8. For example, the parity check information of block 808 can be parity check information associated with parity check bits generated by a corresponding FEC encoder at block 708 of FIG. 7, etc. In some cases, the quantity of parity bits divided by a sum of the quantity of shaped bits and the quantity of parity bits is greater than or equal to the threshold native code rate determined based on the modulation order.

At block 810, the network device (or component thereof) can decode the modulation symbol from the transmission and the parity check information, the modulation symbol corresponding to the set of shaped bits and the set of parity bits. For example, the decoded modulation symbol can be a decoded modulation symbol corresponding to the output modulation symbol of the FEC encoder at block 710 of process 700 of FIG. 7, etc.

In some cases, the computing device or apparatus configured to perform the process 700 and/or the process 800 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 700 and the process 800 are illustrated as a logical flow diagram, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 700, the process 800, and/or other process described herein, may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a diagram illustrating an example of a system for implementing certain aspects of the present technology. In particular, FIG. 9 illustrates an example of computing system 900 including a processing system 902, which may be for example any computing device making up internal computing system, a remote computing system, a camera, or any component thereof in which the components of the system are in communication with each other using connection 905. Connection 905 may be a physical connection using a bus, or a direct connection into processor 910 (and/or one or more other processors included within and/or associated with the processing system 902), such as in a chipset architecture. Connection 905 may also be a virtual connection, networked connection, or logical connection.

In some aspects, computing system 900 and/or the processing system 902 can be provided as a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

The example processing system 902 includes at least one processing unit (CPU or processor) 910 and connection 905 that communicatively couples various system components including system memory 915, such as read-only memory (ROM) 920 and random access memory (RAM) 925 to processor 910. The processing system 902 may include a cache 912 of high-speed memory connected directly with, in close proximity to, or integrated as part of processor 910 and/or one or more other processors included within and/or associated with the processing system 902.

Processor 910 may include any general-purpose processor and a hardware service or software service, such as services 932, 934, and 936 stored in storage device 930, configured to control processor 910 and/or one or more other processors included within and/or associated with the processing system 902, as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, processing system 902 includes an input device 945, which may represent any number of input mechanisms, such as a microphone for speech, a touch-sensitive screen for gesture or graphical input, keyboard, mouse, motion input, speech, etc. Processing system 902 may also include output device 935, which may be one or more of a number of output mechanisms. In some instances, multimodal systems may enable a user to provide multiple types of input/output to communicate with processing system 902.

Processing system 902 may include communication interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communication interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard, and Visa (EMV) chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910 and/or one or more other processors included within and/or associated with the processing system 902, it causes the system to perform a function. In some aspects, a hardware service that performs a particular function may include the software component stored in a computer-readable medium in connection with the necessary hardware components, such as processor 910 (e.g., and/or one or more other processors included within and/or associated with the processing system 902), connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A network entity for wireless communication, comprising: at least one memory; and at least one processor coupled to the at least one memory, wherein the network entity is configured to: obtain a set of shaped bits encoded according to a probabilistic amplitude shaping (PAS) configuration for a modulation scheme, wherein a quantity of shaped bits in the set of shaped bits is based on a modulation order of the modulation scheme; determine a threshold native code rate for a forward error correction (FEC) encoder, wherein the threshold native code rate is determined based on the modulation order; obtain an encoding configuration for the FEC encoder, wherein the encoding configuration corresponds to the threshold native code rate, and wherein the encoding configuration is obtained from among a plurality of candidate encoding configurations corresponding to a respective plurality of native code rates; generate, using the FEC encoder configured with the encoding configuration, a set of parity bits corresponding to the set of shaped bits, wherein a quantity of parity bits in the set of parity bits is based on the threshold native code rate; and output a modulation symbol of the modulation scheme, the modulation symbol corresponding to the set of shaped bits and the set of parity bits.

Aspect 2. The network entity of Aspect 1, wherein: the encoding configuration is a particular candidate encoding configuration included in the plurality of candidate encoding configurations; and a native code rate of the particular candidate encoding configuration is greater than or equal to the threshold native code rate determined based on the modulation order.

Aspect 3. The network entity of any of Aspects 1 to 2, wherein the modulation order is determined based on a modulation coding scheme (MCS) implemented by a probabilistic amplitude shaping encoder using the PAS configuration.

Aspect 4. The network entity of any of Aspects 1 to 3, wherein the encoding configuration causes the FEC encoder to generate the set of parity bits without performing puncturing.

Aspect 5. The network entity of any of Aspects 1 to 4, wherein the quantity of parity bits divided by a sum of the quantity of shaped bits and the quantity of parity bits is greater than or equal to the threshold native code rate determined based on the modulation order.

Aspect 6. The network entity of any of Aspects 1 to 5, wherein, to determine the threshold native code rate for the FEC encoder, the network entity is configured to: determine a value equal to one half multiplied by the modulation order; and divide a numerator equal to the value minus one by a denominator equal to the value.

Aspect 7. The network entity of any of Aspects 1 to 6, wherein the threshold native code rate for the FEC encoder is greater than or equal to one half the modulation order minus one, divided by one half the modulation order.

Aspect 8. The network entity of any of Aspects 1 to 7, wherein the threshold native code rate is indicative of a minimum code rate configured for the FEC encoder corresponding to the PAS configuration.

Aspect 9. The network entity of any of Aspects 1 to 8, wherein the threshold native code rate is a mother code rate for the FEC encoder without puncturing.

Aspect 10. The network entity of any of Aspects 1 to 9, wherein the encoding configuration is indicative of a parity check matrix for the FEC encoder, the parity check matrix having dimensions corresponding to the threshold native code rate.

Aspect 11. The network entity of any of Aspects 1 to 10, wherein, to obtain the set of shaped bits, the network entity is configured to: obtain the set of shaped bits from a distribution matcher configured with the PAS configuration, wherein the set of shaped bits is a set of shaped systematic bits.

Aspect 12. The network entity of Aspect 11, wherein the distribution matcher is included in a probabilistic amplitude shaping encoder associated with the FEC encoder.

Aspect 13. The network entity of Aspect 12, wherein the threshold native code rate and the encoding configuration for the FEC encoder are determined based on the modulation scheme of the probabilistic amplitude shaping encoder.

Aspect 14. The network entity of any of Aspects 12 to 13, wherein: a shaping gain associated with the probabilistic amplitude shaping encoder and the set of shaped bits corresponds to a target rate matching value for the FEC encoder; and to generate the set of parity bits, the network entity is configured to use a reduced rate matching value for the FEC encoder, wherein the reduced rate matching value is less than the target rate matching value.

Aspect 15. The network entity of Aspect 14, wherein the reduced rate matching value corresponds to zero punctured parity bits by the FEC encoder.

Aspect 16. The network entity of any of Aspects 1 to 15, wherein the FEC encoder is associated with a distribution matcher (DM) implementing the PAS configuration to generate the set of shaped bits from an input set of bits.

Aspect 17. The network entity of any of Aspects 1 to 16, wherein the threshold native code rate for the FEC encoder is determined based on a square root.

Aspect 18. The network entity of any of Aspects 1 to 17, wherein the FEC encoder is a low-density parity check (LDPC) encoder or a polar encoder.

Aspect 19. A network entity for wireless communication, comprising: at least one memory; and at least one processor coupled to the at least one memory, wherein the network entity is configured to: receive a transmission including a modulation symbol corresponding to a set of shaped bits and a set of parity bits encoded according to a probabilistic amplitude shaping (PAS) configuration for a modulation scheme, wherein a quantity of shaped bits in the set of shaped bits is based on a modulation order of the modulation scheme; determine a threshold native code rate for a forward error correction (FEC) decoder, wherein the threshold native code rate is determined based on the modulation order; obtain a decoding configuration for the FEC decoder, wherein the decoding configuration corresponds to the threshold native code rate, and wherein the decoding configuration is obtained from among a plurality of candidate decoding configurations corresponding to a respective plurality of native code rates; determine, using the FEC decoder configured with the decoding configuration, parity check information corresponding to at least one of the modulation symbol or the set of parity bits, wherein a quantity of parity bits in the set of parity bits is based on the threshold native code rate; and decode the modulation symbol from the transmission and the parity check information, the modulation symbol corresponding to the set of shaped bits and the set of parity bits.

Aspect 20. The network entity of Aspect 19, wherein the modulation order is determined based on a modulation coding scheme (MCS) implemented by a probabilistic amplitude shaping encoder using the PAS configuration.

Aspect 21. The network entity of any of Aspects 19 to 20, wherein the decoding configuration causes the FEC decoder to determine the parity check information without puncturing.

Aspect 22. The network entity of any of Aspects 19 to 21, wherein the quantity of parity bits divided by a sum of the quantity of shaped bits and the quantity of parity bits is greater than or equal to the threshold native code rate determined based on the modulation order.

Aspect 23. The network entity of any of Aspects 19 to 22, wherein, to determine the threshold native code rate for the FEC decoder, the network entity is configured to: determine a value equal to one half multiplied by the modulation order; and divide a numerator equal to the value minus one by a denominator equal to the value.

Aspect 24. The network entity of any of Aspects 19 to 23, wherein the threshold native code rate for the FEC decoder is greater than or equal to one half the modulation order minus one, divided by one half the modulation order.

Aspect 25. The network entity of any of Aspects 19 to 24, wherein the threshold native code rate is indicative of a minimum code rate configured for the FEC decoder and corresponding to the PAS configuration.

Aspect 26. The network entity of any of Aspects 19 to 25, wherein the threshold native code rate is a mother code rate for the FEC decoder without puncturing.

Aspect 27. The network entity of any of Aspects 19 to 26, wherein the decoding configuration is indicative of a parity check matrix for the FEC decoder, the parity check matrix having dimensions corresponding to the threshold native code rate.

Aspect 28. The network entity of any of Aspects 19 to 27, wherein the threshold native code rate and the decoding configuration for the FEC decoder are based on the modulation scheme.

Aspect 29. The network entity of any of Aspects 19 to 28, wherein the FEC decoder is a low-density parity check (LDPC) decoder or a polar decoder.

Aspect 30. A method for wireless communication, comprising: obtaining a set of shaped bits encoded according to a probabilistic amplitude shaping (PAS) configuration for a modulation scheme, wherein a quantity of shaped bits in the set of shaped bits is based on a modulation order of the modulation scheme; determining a threshold native code rate for a forward error correction (FEC) encoder, wherein the threshold native code rate is determined based on the modulation order; obtaining an encoding configuration for the FEC encoder, wherein the encoding configuration corresponds to the threshold native code rate, and wherein the encoding configuration is obtained from among a plurality of candidate encoding configurations corresponding to a respective plurality of native code rates; generating, using the FEC encoder configured with the encoding configuration, a set of parity bits corresponding to the set of shaped bits, wherein a quantity of parity bits in the set of parity bits is based on the threshold native code rate; and outputting a modulation symbol of the modulation scheme, the modulation symbol corresponding to the set of shaped bits and the set of parity bits.

Aspect 31. The method of Aspect 30, wherein: the encoding configuration is a particular candidate encoding configuration included in the plurality of candidate encoding configurations; and a native code rate of the particular candidate encoding configuration is greater than or equal to the threshold native code rate determined based on the modulation order.

Aspect 32. The method of any of Aspects 30 to 31, wherein the modulation order is determined based on a modulation coding scheme (MCS) implemented by a probabilistic amplitude shaping encoder using the PAS configuration.

Aspect 33. The method of any of Aspects 30 to 32, wherein the encoding configuration causes the FEC encoder to generate the set of parity bits without performing puncturing.

Aspect 34. The method of any of Aspects 30 to 33, wherein the quantity of parity bits divided by a sum of the quantity of shaped bits and the quantity of parity bits is greater than or equal to the threshold native code rate determined based on the modulation order.

Aspect 35. The method of any of Aspects 30 to 34, wherein determining the threshold native code rate for the FEC encoder includes: determining a value equal to one half multiplied by the modulation order; and dividing a numerator equal to the value minus one by a denominator equal to the value.

Aspect 36. The method of any of Aspects 30 to 35, wherein the threshold native code rate for the FEC encoder is greater than or equal to one half the modulation order minus one, divided by one half the modulation order.

Aspect 37. The method of any of Aspects 30 to 36, wherein the threshold native code rate is indicative of a minimum code rate configured for the FEC encoder corresponding to the PAS configuration.

Aspect 38. The method of any of Aspects 30 to 37, wherein the threshold native code rate is a mother code rate for the FEC encoder without puncturing.

Aspect 39. The method of any of Aspects 30 to 38, wherein the encoding configuration is indicative of a parity check matrix for the FEC encoder, the parity check matrix having dimensions corresponding to the threshold native code rate.

Aspect 40. The method of any of Aspects 30 to 39, wherein obtaining the set of shaped bits includes: obtaining the set of shaped bits from a distribution matcher configured with the PAS configuration, wherein the set of shaped bits is a set of shaped systematic bits.

Aspect 41. The method of Aspect 40, wherein the distribution matcher is included in a probabilistic amplitude shaping encoder associated with the FEC encoder.

Aspect 42. The method of Aspect 41, wherein the threshold native code rate and the encoding configuration for the FEC encoder are determined based on the modulation scheme of the probabilistic amplitude shaping encoder.

Aspect 43. The method of any of Aspects 41 to 42, wherein: a shaping gain associated with the probabilistic amplitude shaping encoder and the set of shaped bits corresponds to a target rate matching value for the FEC encoder; and generating the set of parity bits is based on using a reduced rate matching value for the FEC encoder, wherein the reduced rate matching value is less than the target rate matching value.

Aspect 44. The method of Aspect 43, wherein the reduced rate matching value corresponds to zero punctured parity bits by the FEC encoder.

Aspect 45. The method of any of Aspects 30 to 44, wherein the FEC encoder is associated with a distribution matcher (DM) implementing the PAS configuration to generate the set of shaped bits from an input set of bits.

Aspect 46. The method of any of Aspects 30 to 45, wherein the threshold native code rate for the FEC encoder is determined based on a square root.

Aspect 47. The method of any of Aspects 30 to 46, wherein the FEC encoder is a low-density parity check (LDPC) encoder or a polar encoder.

Aspect 48. A method for wireless communication, comprising: receiving a transmission including a modulation symbol corresponding to a set of shaped bits and a set of parity bits encoded according to a probabilistic amplitude shaping (PAS) configuration for a modulation scheme, wherein a quantity of shaped bits in the set of shaped bits is based on a modulation order of the modulation scheme; determining a threshold native code rate for a forward error correction (FEC) decoder, wherein the threshold native code rate is determined based on the modulation order; obtaining a decoding configuration for the FEC decoder, wherein the decoding configuration corresponds to the threshold native code rate, and wherein the decoding configuration is obtained from among a plurality of candidate decoding configurations corresponding to a respective plurality of native code rates; determining, using the FEC decoder configured with the decoding configuration, parity check information corresponding to at least one of the modulation symbol or the set of parity bits, wherein a quantity of parity bits in the set of parity bits is based on the threshold native code rate; and decoding the modulation symbol from the transmission and the parity check information, the modulation symbol corresponding to the set of shaped bits and the set of parity bits.

Aspect 49. The method of Aspect 48, wherein the modulation order is determined based on a modulation coding scheme (MCS) implemented by a probabilistic amplitude shaping encoder using the PAS configuration.

Aspect 50. The method of any of Aspects 48 to 49, wherein the decoding configuration causes the FEC decoder to determine the parity check information without puncturing.

Aspect 51. The method of any of Aspects 48 to 50, wherein the quantity of parity bits divided by a sum of the quantity of shaped bits and the quantity of parity bits is greater than or equal to the threshold native code rate determined based on the modulation order.

Aspect 52. The method of any of Aspects 48 to 51, wherein determining the threshold native code rate for the FEC decoder includes: determining a value equal to one half multiplied by the modulation order; and dividing a numerator equal to the value minus one by a denominator equal to the value.

Aspect 53. The method of any of Aspects 48 to 52, wherein the threshold native code rate for the FEC decoder is greater than or equal to one half the modulation order minus one, divided by one half the modulation order.

Aspect 54. The method of any of Aspects 48 to 53, wherein the threshold native code rate is indicative of a minimum code rate configured for the FEC decoder and corresponding to the PAS configuration.

Aspect 55. The method of any of Aspects 48 to 54, wherein the threshold native code rate is a mother code rate for the FEC decoder without puncturing.

Aspect 56. The method of any of Aspects 48 to 55, wherein the decoding configuration is indicative of a parity check matrix for the FEC decoder, the parity check matrix having dimensions corresponding to the threshold native code rate.

Aspect 57. The method of any of Aspects 48 to 56, wherein the threshold native code rate and the decoding configuration for the FEC decoder are based on the modulation scheme.

Aspect 58. The method of any of Aspects 48 to 57, wherein the FEC decoder is a low-density parity check (LDPC) decoder or a polar decoder.

Aspect 59. A non-transitory computer-readable storage medium comprising instructions stored thereon which, when executed by at least one processor, causes the at least one processor to perform operations according to any of Aspects 1 to 18.

Aspect 60. An apparatus for wireless communication comprising one or more means for performing operations according to any of Aspects 1 to 18.

Aspect 61. A non-transitory computer-readable storage medium comprising instructions stored thereon which, when executed by at least one processor, causes the at least one processor to perform operations according to any of Aspects 19 to 29.

Aspect 62. An apparatus for wireless communication comprising one or more means for performing operations according to any of Aspects 19 to 29.

What is claimed is:

1. A network entity for wireless communication, comprising:
at least one memory; and
at least one processor coupled to the at least one memory, wherein the network entity is configured to:
obtain a set of shaped bits encoded according to a probabilistic amplitude shaping (PAS) configuration for a modulation scheme, wherein a quantity of shaped bits in the set of shaped bits is based on a modulation order of the modulation scheme;
determine a threshold native code rate for a forward error correction (FEC) encoder, wherein the threshold native code rate is determined based on the modulation order;
obtain an encoding configuration for the FEC encoder, wherein the encoding configuration corresponds to the threshold native code rate, and wherein the encoding configuration is obtained from among a plurality of candidate encoding configurations corresponding to a respective plurality of native code rates;
generate, using the FEC encoder configured with the encoding configuration, a set of parity bits corresponding to the set of shaped bits, wherein a quantity of parity bits in the set of parity bits is based on the threshold native code rate; and
output a modulation symbol of the modulation scheme, the modulation symbol corresponding to the set of shaped bits and the set of parity bits.

2. The network entity of claim 1, wherein:
the encoding configuration is a particular candidate encoding configuration included in the plurality of candidate encoding configurations; and
a native code rate of the particular candidate encoding configuration is greater than or equal to the threshold native code rate determined based on the modulation order.

3. The network entity of claim 1, wherein the modulation order is determined based on a modulation coding scheme (MCS) implemented by a probabilistic amplitude shaping encoder using the PAS configuration.

4. The network entity of claim 1, wherein the encoding configuration causes the FEC encoder to generate the set of parity bits without performing puncturing.

5. The network entity of claim 1, wherein the quantity of parity bits divided by a sum of the quantity of shaped bits and the quantity of parity bits is greater than or equal to the threshold native code rate determined based on the modulation order.

6. The network entity of claim 1, wherein, to determine the threshold native code rate for the FEC encoder, the network entity is configured to:
determine a value equal to one half multiplied by the modulation order; and
divide a numerator equal to the value minus one by a denominator equal to the value.

7. The network entity of claim 1, wherein the threshold native code rate for the FEC encoder is greater than or equal to one half the modulation order minus one, divided by one half the modulation order.

8. The network entity of claim 1, wherein the threshold native code rate is indicative of a minimum code rate configured for the FEC encoder corresponding to the PAS configuration.

9. The network entity of claim 1, wherein the threshold native code rate is a mother code rate for the FEC encoder without puncturing.

10. The network entity of claim 1, wherein the encoding configuration is indicative of a parity check matrix for the FEC encoder, the parity check matrix having dimensions corresponding to the threshold native code rate.

11. The network entity of claim 1, wherein, to obtain the set of shaped bits, the network entity is configured to:
obtain the set of shaped bits from a distribution matcher configured with the PAS configuration, wherein the set of shaped bits is a set of shaped systematic bits.

12. The network entity of claim 11, wherein the distribution matcher is included in a probabilistic amplitude shaping encoder associated with the FEC encoder.

13. The network entity of claim 12, wherein the threshold native code rate and the encoding configuration for the FEC encoder are determined based on the modulation scheme of the probabilistic amplitude shaping encoder.

14. The network entity of claim 12, wherein:
a shaping gain associated with the probabilistic amplitude shaping encoder and the set of shaped bits corresponds to a target rate matching value for the FEC encoder; and
to generate the set of parity bits, the network entity is configured to use a reduced rate matching value for the FEC encoder, wherein the reduced rate matching value is less than the target rate matching value.

15. The network entity of claim 14, wherein the reduced rate matching value corresponds to zero punctured parity bits by the FEC encoder.

16. The network entity of claim 1, wherein the FEC encoder is associated with a distribution matcher (DM) implementing the PAS configuration to generate the set of shaped bits from an input set of bits.

17. The network entity of claim 1, wherein the threshold native code rate for the FEC encoder is determined based on a square root.

18. The network entity of claim 1, wherein the FEC encoder is a low-density parity check (LDPC) encoder or a polar encoder.

19. A network entity for wireless communication, comprising:
at least one memory; and
at least one processor coupled to the at least one memory, wherein the network entity is configured to:
receive a transmission including a modulation symbol corresponding to a set of shaped bits and a set of parity bits encoded according to a probabilistic amplitude shaping (PAS) configuration for a modulation scheme, wherein a quantity of shaped bits in the set of shaped bits is based on a modulation order of the modulation scheme;
determine a threshold native code rate for a forward error correction (FEC) decoder, wherein the threshold native code rate is determined based on the modulation order;
obtain a decoding configuration for the FEC decoder, wherein the decoding configuration corresponds to the threshold native code rate, and wherein the decoding configuration is obtained from among a plurality of candidate decoding configurations corresponding to a respective plurality of native code rates;
determine, using the FEC decoder configured with the decoding configuration, parity check information corresponding to at least one of the modulation symbol or the set of parity bits, wherein a quantity of parity bits in the set of parity bits is based on the threshold native code rate; and
decode the modulation symbol from the transmission and the parity check information, the modulation symbol corresponding to the set of shaped bits and the set of parity bits.

20. The network entity of claim 19, wherein the modulation order is determined based on a modulation coding scheme (MCS) implemented by a probabilistic amplitude shaping encoder using the PAS configuration.

21. The network entity of claim 19, wherein the decoding configuration causes the FEC decoder to determine the parity check information without puncturing.

22. The network entity of claim 19, wherein the quantity of parity bits divided by a sum of the quantity of shaped bits and the quantity of parity bits is greater than or equal to the threshold native code rate determined based on the modulation order.

23. The network entity of claim 19, wherein, to determine the threshold native code rate for the FEC decoder, the network entity is configured to:
determine a value equal to one half multiplied by the modulation order; and
divide a numerator equal to the value minus one by a denominator equal to the value.

24. The network entity of claim 19, wherein the threshold native code rate for the FEC decoder is greater than or equal to one half the modulation order minus one, divided by one half the modulation order.

25. The network entity of claim 19, wherein the threshold native code rate is indicative of a minimum code rate configured for the FEC decoder and corresponding to the PAS configuration.

26. The network entity of claim 19, wherein the threshold native code rate is a mother code rate for the FEC decoder without puncturing.

27. The network entity of claim 19, wherein the decoding configuration is indicative of a parity check matrix for the FEC decoder, the parity check matrix having dimensions corresponding to the threshold native code rate.

28. The network entity of claim 19, wherein the threshold native code rate and the decoding configuration for the FEC decoder are based on the modulation scheme.

29. A method for wireless communication, comprising:
obtaining a set of shaped bits encoded according to a probabilistic amplitude shaping (PAS) configuration for a modulation scheme, wherein a quantity of shaped bits in the set of shaped bits is based on a modulation order of the modulation scheme;
determining a threshold native code rate for a forward error correction (FEC) encoder, wherein the threshold native code rate is determined based on the modulation order;
obtaining an encoding configuration for the FEC encoder, wherein the encoding configuration corresponds to the threshold native code rate, and wherein the encoding configuration is obtained from among a plurality of candidate encoding configurations corresponding to a respective plurality of native code rates;
generating, using the FEC encoder configured with the encoding configuration, a set of parity bits corresponding to the set of shaped bits, wherein a quantity of parity bits in the set of parity bits is based on the threshold native code rate; and
outputting a modulation symbol of the modulation scheme, the modulation symbol corresponding to the set of shaped bits and the set of parity bits.

30. A method for wireless communication, comprising:
receiving a transmission including a modulation symbol corresponding to a set of shaped bits and a set of parity bits encoded according to a probabilistic amplitude shaping (PAS) configuration for a modulation scheme, wherein a quantity of shaped bits in the set of shaped bits is based on a modulation order of the modulation scheme;
determining a threshold native code rate for a forward error correction (FEC) decoder, wherein the threshold native code rate is determined based on the modulation order;
obtaining a decoding configuration for the FEC decoder, wherein the decoding configuration corresponds to the threshold native code rate, and wherein the decoding configuration is obtained from among a plurality of candidate decoding configurations corresponding to a respective plurality of native code rates;
determining, using the FEC decoder configured with the decoding configuration, parity check information corresponding to at least one of the modulation symbol or the set of parity bits, wherein a quantity of parity bits in the set of parity bits is based on the threshold native code rate; and
decoding the modulation symbol from the transmission and the parity check information, the modulation symbol corresponding to the set of shaped bits and the set of parity bits.
